(19) United States
(12) Patent Application Publication
(10) Pub. No.: US 2006/0058900 A1
(43) Pub. Date: Mar. 16, 2006

(54) User interface for a building control system configurator

(76) Inventors: Thomas E. Johanson, Palatine, IL (US); Joseph Whitehead, Palatine, IL (US); James L. Kruk, Huntley, IL (US); Scott Lambert, Buffalo Grove, IL (US); Brian Gillespie, Byron Center, MI (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/051,773

(22) Filed: Feb. 4, 2005

Related U.S. Application Data
(60) Provisional application No. 60/608,968, filed on Sep. 10, 2004.

(51) Int. Cl. G05B 15/00

(52) U.S. Cl. 700/83

(57) ABSTRACT

A user interface for designing a control system displays features of the control system to be configured. Options for a feature are determined and displayed when a feature is selected to be configured. A selection of an available option may be made and one or more corresponding control system components are identified and displayed. After the selection of an available option, the available options for the other features may be altered based upon the available option selected. A plurality of options for the other features also may be automatically identified taking into account the available option selected.

### PRIORITY AND CROSS-REFERENCE TO RELATED APPLICATION

This is application claims priority under 35 U.S.C. § 119(e) to co-pending provisional application No. 60/608,968, filed on Sep. 10, 2004, entitled METHOD FOR CONFIGURING A BUILDING CONTROL SYSTEM, which is incorporated in its entirety herein.

### BACKGROUND

The present invention relates to building automation systems. In particular, a configurator engine assists in configuring an automated building control system.

Building automation systems automate control of building systems and networks such as security, fire, hazard prevention, heating, ventilation, air conditioning (HVAC) or other control systems for buildings. For example, a building automation system includes controllers, sensors, actuators, chillers, fans, humidifiers, and/or air handling units that are positioned in the building and configured to provide a desired environment for the building or portion thereof. The components may be deployed individually or as groups to provide the desired control. For example, a temperature sensor or thermostat positioned in a room provides a temperature reading or signal to a controller, and the controller generates a control signal for an actuator located in the room to effect changes in heating and/or cooling of the room.

Current building automation systems are manually designed, engineered and/or configured. A component or groups of components are individually and manually identified according to a specification or perceived needs for a building or particular areas of the building. Once a component or groups of components is identified, other components that may be necessary for the proper operation of the identified components within the system must also be manually and individually identified. For example, a building having a humidifier will also require a humidity sensor to provide feedback control for the humidifier. Once a building automation system is designed and its components identified, system plans may be developed, a list of components created, and an estimate calculated. However, manual configuration is labor-intensive, time-consuming and prone to errors. Estimates also may be inaccurate which may result in a delay in the fulfillment of the system.

### BRIEF SUMMARY

By way of introduction, the embodiments described below include methods, processes, apparatuses, and systems for configuring a building automation system according to a rules-based interface for selecting parameters of a desired building automation system.

The building automation system configurator provides an interface or tool-kit for designing, creating, customizing or configuring building control systems based on parameters or features of the building control system. The building automation system configurator follows predetermined rules to guide a user, such as a building automation system designer or estimator, through a building automation design to ensure proper identification of appropriate components of a configurable building automation system. A user is presented with predetermined options or choices for discrete features of the system. The options are controlled according to the predetermined rules, such as engineering considerations for a configurable system.

Using the configurator, a user selects a predetermined option for a configuration of a feature. Based on the selected options for the features, equipment, components, control strategies or any other criteria are identified. When a predetermined option for a feature is chosen, the selection is recorded, and components that provide the feature are identified. The configurator identifies features for which a selection is required in order to complete a configured system. Based on the selections, the configurator identifies some, all, or substantially all components for a configured system.

When a system has been designed or configured, a data set associated with the identified components or groups of components is populated. The data set may include data associated with each identified component and its relation to other selected components. The data set is used to generate reports, such as estimates, component lists, schematics, graphical representations, control point lists and/or programming code for a controller of the configured system. The data set also may be merged or integrated with data sets representing other configured areas of a building control system.

The configurator may be used to create a project that has any combination of configurable, static or custom applications. When a system has been configured, a data set is created from which a cost for the system may be identified. The configurator may be used to amend or otherwise modify the cost, and determine costs for control points. Outputs may be viewed, saved and printed as part of a project representing a configured system. Reports may be generated, and systems may be adjusted or integrated with other configured systems.

In a first aspect, a method for designing a control system via a user interface is provided. The method may include displaying a feature list within an user interface on a display screen, the feature list including selectable features of a control system, and displaying an option list, the option list including available options for a corresponding selectable feature that include control system components or characteristics. The method also may include displaying an available option selected, generating a plurality of option lists corresponding to selectable features, and updating a plurality of the option lists to reflect which options are available for selection for the respective selectable features based upon the options currently selected.

In a second aspect, a user interface for designing a buiding control system is provided. The user interface may include a feature list displayed on a display screen, the feature list includes selectable features for building control system components and characteristics of a building control system, and an option list displayed on the display screen, the option list includes available options for a corresponding selectable feature, wherein after the selection of an available option from the option list, the available option selected is displayed. The user interface may also include a plurality of option lists, wherein after the selection of an available option, a plurality of option lists are updated to reflect which options are available for selection for the respective selectable features based upon the options currently selected.

In a third aspect, a graphical user interface for designing a control system is provided. The graphical user interface may include a window for selecting a plurality of features of a control system; a feature list displayed within the window, the feature list includes features of the control system; a selection list displayed within the window, the selection list includes any options currently selected, each option currently selected corresponding to a feature listed in the feature list; a plurality of option lists accessible from the window, each option list corresponding to a feature listed in the feature list, each option list includes the available options for the corresponding feature; and an option list displayed as part of the graphical user interface. Upon the selection of an available option listed in the option list displayed, a plurality of option lists corresponding to remaining features not having an option selected are updated to reflect any changes in the options available for selection for the respective remaining features based upon the options currently selected.

In a fourth aspect, a computer-readable medium having instructions executable on a computer stored thereon is provided. The instructions may control displaying selectable features for building control system components and characteristics using a graphical user interface, providing a corresponding list of available options for each selectable feature, receiving data associated with an user-selected option, storing data associated with the user-selected option, and determining whether the available options in a plurality of the lists should be altered based upon the user-selected option. The instructions may further control automatically selecting an option for a plurality of selectable features based upon a plurality of user-selected options.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a exemplary building automation system;

FIG. 2 is a diagrammatic representation for an exemplary building automation system configurator;

FIG. 3 is a block diagram of a processor adapted as a building automation system configurator of FIG. 2;

FIG. 4 illustrates a display for a graphics user interface for a building automation system configurator of FIG. 3;

FIG. 5 illustrates an example of a project tile of the graphic user interface of FIG. 4;

FIGS. 6a and 6b illustrate examples of a parameters tile of the graphic user interface of FIG. 4;

FIGS. 7 to 28 illustrate example display screens for a parameters tile of the graphic user interface of FIG. 4;

FIG. 29 illustrates an example of a task tile of the graphics user interface of FIG. 4;

FIG. 30 illustrates an example of a task tile of the graphics user interface of FIG. 4; and

FIG. 31 illustrates an example of a mechanics interface tile of the graphic user interface of FIG. 4.

### DETAILED DESCRIPTION OF THE DRAWINGS AND PRESENTLY PREFERRED EMBODIMENTS

Building control systems may be configured by selecting features of a desired system where choices for the features are presented according to engineering rules for configuring the building control system. By controlling a component or building control system features selection process, the configurator guides a designer through a configuration process to ensure a complete or desired building control system. As a system is being configured, features are selected, corresponding components are identified and a database storing a data set of selected features and/or identified components is populated. The configurator tracks selections made by a designer to determine whether a configurable system is complete and whether there are further selections to be made.

When a system is configured, the populated database storing the data set associated with the selected items is accessed to provide information about the configured system. The information is generated by processing data in the populated database. The generated information includes an estimate for implementing the configured system, and a description of the configured system. The generated information also includes schematic diagrams, a control point list, a programming code for control of the configured system, and any other information that may be generated using the data associated with the selected components or features.

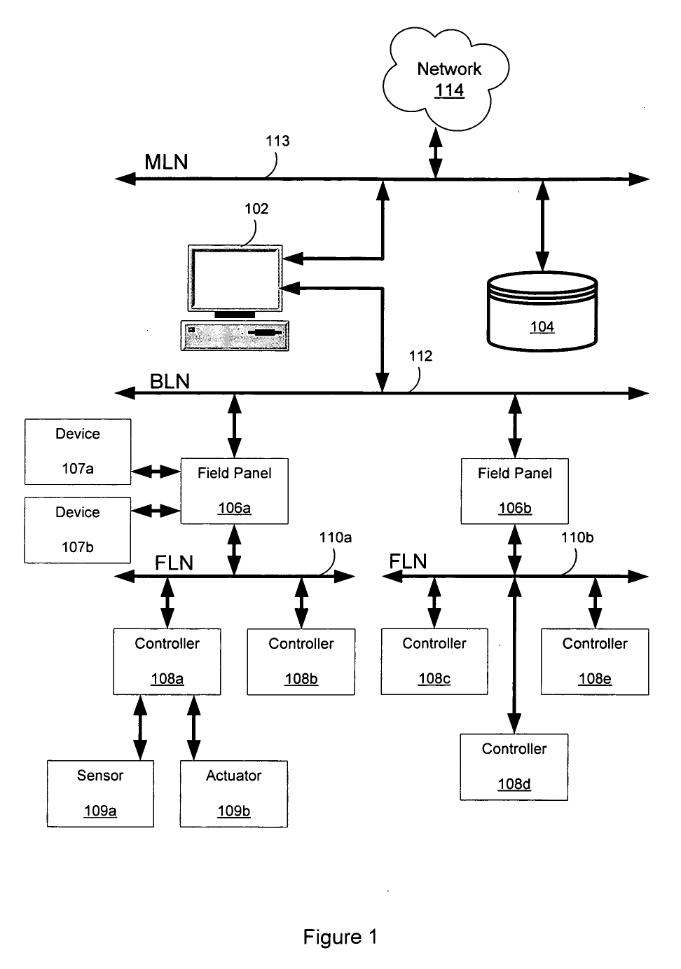

FIG. 1 illustrates a block diagram for an example of a configured building control system 100. The building control system 100 is provided only as an example of a type of system that may be configured. The building control system configurator is not limited to the illustrated system and may be used to configure, design and render any control system. A configurator also may be used for other types of building controls system other than the types described with respect to FIG. 1.

The building control system 100 is a distributed control system that provides control functions for one or more building control operations. The types of building control systems include heating ventilation and air conditioning (HVAC), security, loss prevention, hazard detection and/or prevention, lighting, industrial control, combinations thereof, and the like. An example of a building control system is an APOGEE™ system provided by Siemens Building Technologies, Inc. of Buffalo Grove, Ill. The APOGEE™ system allows the setting and/or changing of various controls of the system.

The exemplary building control system 100 includes at least one supervisory control system or workstation 102, a system database, one or more field panels 106a, 106b, and one or more controllers 108a-108e. Each controller 108a-108e corresponds to an associated localized, standard building control subsystem. The building control subsystem may be a space temperature control subsystem, lighting control subsystem, hazard detection subsystem, security subsystem, combinations thereof, or the like. A controller for the building control subsystems may be, for example, a Terminal Equipment Controller (TEC) provided by Siemens Building Technologies, Inc. of Buffalo Grove, Ill.

To control an associated subsystem, each controller 108a-108e is coupled to one or more sensors 109a. The controllers 108a-108e also are operatively coupled to one or more actuators 109b. For example, sensor 109a and actuator 109b are coupled to the controller 108a. The controller 108a provides control functionality of each, one or both of the sensor 109a and actuator 109b.

A controller 108a controls a subsystem based on sensed conditions and desired set point conditions. The controller 108a controls the operation of one or more actuators to drive a condition sensed by a sensor 109a to a desired set point condition. The controller 108a is programmed with the set points and a code setting forth instructions that are executed by the controller for controlling the actuators to drive the sensed condition to the set point. For example, in an environmental control system that is controlled by controller 108a, the actuator 109b is operatively connected to an air conditioning damper. A sensor 109a may be a room temperature sensor that provides a feedback signal to the controller associated with a present temperature sensed by the sensor or associated with a relative temperature change. If the sensed temperature sensed by the sensor 109a exceeds a predetermined threshold, the controller provides a control signal to the actuator to open a damper, allowing air conditioning to flow into a room. Similarly, if the temperature sensor 109a detects a temperature drop below a lower threshold, then the controller operates to close the damper, reducing flow of cool air in the room. The controller will therefore attempt to bring the temperature within a range of set points or thresholds.

In the exemplary building control system 100, sensor, actuator, and set point information are shared among controller 108a-108e, the field panels 106a-106b, the work station 102, and any other components or elements that may affect control of the building control system 100. To facilitate sharing of information, groups of subsystems such as those coupled to controllers 108a and 108b are organized into floor level networks (“FLN's”) and generally interface the field panel 106a. The FLN data network 110a is a low-level data network that may use any suitable protocol. The protocol may be proprietary or open. Controllers 108c, 108d and 108e along with the field panel 106b are similarly coupled via a low-level FLN data network 110b. Any of a wide variety of FLN architectures may be used.

The field panels 106a and 106b are also coupled via a building level network (BLN) 112 to the workstation 102. The workstation 102 is a supervisory computer. The workstation 102 is coupled to a database 104. The field panels 106a and 106b coordinate communication of data, information and signals between the controllers 108a-108e and the workstation 102 and database 104. In addition, one or more of the field panels 106a and 106b may have control programs for controlling actuators. For example, the field panels 106a and 106b are programmed to control HVAC actuators associated with air handlers and the like. The field panel 106a is operatively coupled to one or more HVAC system devices, shown for example as sensor 107a and actuator 107b.

The workstation 102 provides overall control and monitoring of the building control system 100 and includes a user interface. The workstation 102 further operates as a building control system data server that exchanges data with one or more components of the building control system 100. As a data server for the building control system 100, the workstation 102 can also exchange data with a database 104 and may also allow access to the building control system data by various applications. The applications are executed on the workstation 102 or other supervisory computers that may be communicatively coupled via a management level network (MLN) 113.

The workstation allows access to the components of the building control system 100, such as the field panels 106a and 106b. The workstation 102 also accepts modifications, changes, and alterations to the system. For example, a user may use the workstation 102 to reprogram set points for a subsystem via a user interface. The user interface may be an input device or combination of input devices, such as a keyboard, voice-activated response system, a mouse or similar device. The workstation 102 is operable to affect or change operations of the field panels 106a and 106b, utilize the data and/or instructions from the workstation 102 and/or provide control of connected devices, such as devices 107a and 107b and/or the controllers 108a and 108b.

The workstation 102 polls or queries the field panels 106a and 106b to gather data. The workstation 102 processes the data received from the field panels 106a and 106b, including maintaining a log of field panel events and/or logging thereof. Information and/or data are thus gathered from the field panels 106a and 106b in connection with the polling, query or otherwise, which the workstation 102 may store, log, and/or process. The field panels 106a and 106b therefore accept the modifications, changes, alterations and the like from the user.

The workstation 102 also maintains a database associated with each field panel 106a and 106b. The database maintains operational and configuration data for the association field panel. The workstation 102 is communicatively coupled to a web server. For example, the workstation 102 may be coupled to communicate with a web server via the MLN 113 through an Ethernet network. The workstation 102 uses the MLN 113 to communicate building control system data to and from other elements on the MLN 113, including the web server 114. The database 104 stores historical data, error data, system configuration data, graphical data, and other building control system information as appropriate.

The MLN 113 is connected to other supervisory computers, servers, or gateways. For example, the MLN 113 may be coupled to the web server 114 to communicate with external devices and other network managers. The MLN 113 may include an Ethernet or similar network. The MLN 113 may be configured to communicate according to known communication protocols such as TCP/IP, BACnet, and/or other communication protocols suitable for sharing large amounts of data.

The field panels 106a and 106b accept modification, changes, alterations, and the like from the user with respect to objects defined by the building control system 100. The objects are various parameters, control and/or set points, port modifications, terminal definitions, users, date/time data, alarms and/or alarm definitions, modes, and/or programming of the field panel itself, another field panel, and/or any controller in communication with a field panel.

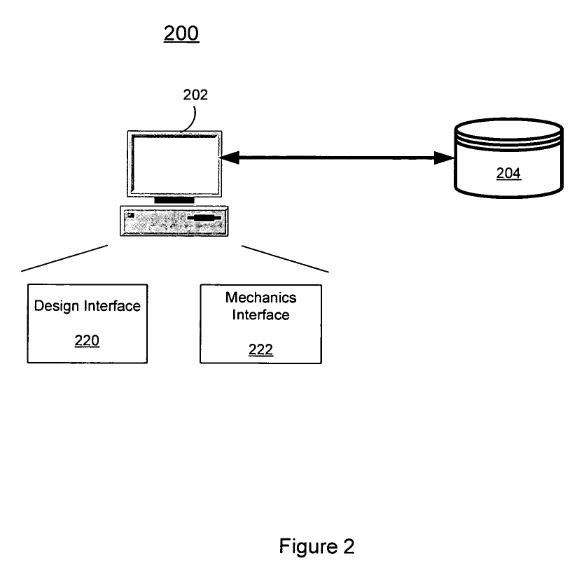

The building control system 100 of FIG. 1 is configured or designed using a building control system configurator. FIG. 2 illustrates a block diagram for a building control system configurator 200. The exemplary configurator 200 includes a data processor 202 operatively coupled to a database 204. Any data processors, computers, databases, data storage, and controller systems such as personal computers, notebook computers, computer networks, workstations, mainframe computers, servers, and the like may be used. The configurator 200 also may be embodied as computer software or firmware including object and/or source code, hardware, or a combination of software and hardware. The configurator 200 may be stored on a computer-readable medium installed on, deployed by, resident on, invoked by and/or used by one or more data processors 202 computers, clients, servers, gateways, or a network of computers, or any combination thereof. The computers, servers, gateways, may have a controller capable of carrying out instructions embodied as computer software. The configurator 200 may be implemented using any known software platform or frameworks including basic, visual basic, C, C+, C++, J2EE™, Oracle 9i, XML, API based designs, and like component-based software platforms. The configurator 200 also may interface with other word processing and graphics software and systems, such as computer-aided drawing systems.

The database 204 includes a single file or a collection of files composed of organized records having one or more fields of data. The data is retrieved and stored in the database 204. The data processor 202 interfaces the database 204 for storage and retrieval of data. Components of the configurator 200 reside in memory and/or storage during operation of the data processor 202. Although shown separately, the database 204 may be a unitary component of the data processor 202.

In an embodiment, the database 204 provides storage of data processed by the configurator 200. The data includes information to identify and format a project. A project includes one or more independent or integrated building control systems. The project information includes, for example, the units of measurement, country for the project, language, project name, company name, customer name, customer contact, division number, address, e-mail, and website, contact information, and/or any other information that may be used to identify a project. The information may be manually input to the configuration, previously stored, or imported to the database. The data also may include information related to the scope of components including control wiring, type, power wiring, interlocks, dampers, smoke detectors, terminal unit controllers, terminal unit actuators, chiller flow switches, boiler flow switches, and the like.

The database also stores data associated with selectable features and components of a building automation system 100. For example, the database stores information associated with components and the relationship of the components with selectable features of a building automation system. The features include type of actuation, controller type, temperature detectors, thermostats, piping configurations, valve types, fan types, pressure sensors, duct sensor, wiring options, and any other type of component that may be used in a building automation system. Information identifying the components of a building automation system are also stored in the database 204 with the components engineering specifications, and its attributes and relations to particular features.

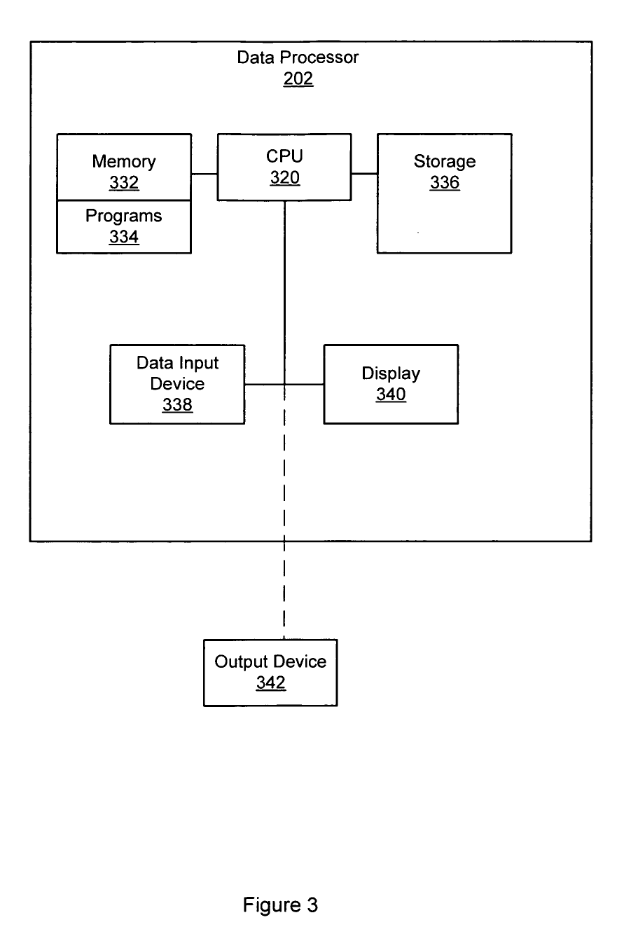

FIG. 3 illustrates an exemplary data processor 202 configured or adapted to provide a building control system configurator 200. The data processor 202 is provided for descriptive purposes and is not intended to limit the scope of the enterprise system. The data processor 202 includes a central processing unit (CPU) 320, a memory 332, a storage device 336, a data input device 338, and a display 340. The processor 202 also may have an external output device 342, which may be a display, monitor, a printer or a communications port. A program 334 resides on the memory 332 and includes one or more sequences of executable code or coded instructions that are executed by the CPU. The program 334 is loaded into the memory 332 from storage device 336. The CPU 320 executes one or more sequences of instructions of the program 334 to process data. Data is input to the data processor 202 with data input device 338. The program 334 interfaces data input device 338 for the input of data. Data processed by the data processor 202 is provided as an output to the display 340, external output device 342 and/or stored in the database 204.

The data processor 202 may be configured to provide the functionality of the building automation system configurator 200. The processor 202 follows instructions of the program 334 in memory 332 to provide the features of the configurator 200. As shown in FIG. 2, the configurator 200 provides a design interface 220 and a mechanics interface 222.

Using the design interface 220, a user such as a designer, may configure a building automation system 100 by providing responses to selections for features of the building automation system to be configured. The user configures or designs various independent areas of a building as part of a project for the building. The areas are configured and saved as a discrete part of an overall project. While a system 100 is being configured, the status of the system may be displayed to the user. The status identifies features, areas, components, or groups of components that have been selected and areas to be configured or outstanding features or tasks for completion. As the selections are made, components of the system are identified and a data set representing the selected features and/or components is populated. The populated data set is stored in the database 204 or any other storage medium.

The mechanics interface 222 includes data processing engines to filter and process data associated with a configured system to generate reports, diagrams, descriptions, programs, lists and estimates for a configured system. The mechanics interface 222 references the populated data set to access the data associated with the selected features and/or identified components of the configured system 100. The data processing engines generate representations of the configured system 100 using the data of the populated data set. For example, the data associated with selected features and/or components may be filtered and processed by a graphics engine to generate an iconic or graphic diagram of the configured system. The data also may be filtered and merged with a template to generate a description of the configured system, a components list, list of control points, a program code of instructions for a controller of the configured system, mechanical and electrical schematics, cost estimates and other descriptive representations of the configured system. Using the mechanics interface, a user may invoke any of the engines to generate a desired output or mechanical representation of the configured system.

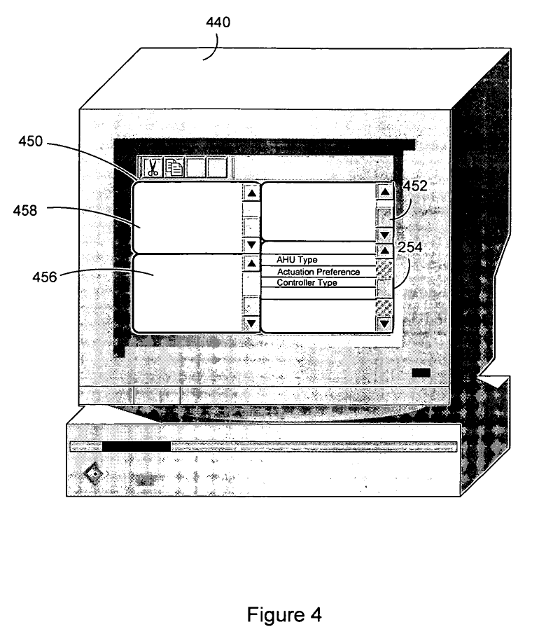

FIG. 4 illustrates a graphical user interface (GUI) 450 of an exemplary configurator 200. In the example shown in FIG. 4, the GUI 450 is displayed on a monitor 440 of the processor 202. Using a data input device, a user interfaces the GUI 450 to create and save projects, configure and save areas of building automation systems, input selections, make edits, track tasks needing completion, and generate outputs representing a configured system or data related to a configured system. The data input device may be a keyboard, a computer mouse or mouse-type device, a voice-activated interface, a touch screen display, combinations thereof or any other computer input device.

The GUI 450 integrates the design interface 220 and mechanics interface 222 on a single screen or displays them separately. The GUI 450 includes multiple task specific tiles or windows 452-458, where each of the tiles 452-458 provide an interface for the design interface and/or the mechanics interface. The tiles 452-458 may be arranged, configured and positioned individually or together in any location on the display 440. For example, a user may chose to place tile 452 in the lower right corner of the display by “clicking-and-dragging” the tile to the desired location. The user also may adjust the tiles 452-458 to have a desired size on the display 440 by “clicking-and-dragging” an edge of the tile to adjust the size of the tile.

In an embodiment, tile 452 is configured to provide information related to an open project. Tile 454 is configured to present property options or alternative features for configuring a building automation system. Tile 456 is configured to track tasks for an open project. Tile 458 is configured to provide selections for generating mechanical representations of a configured system or a substantially configured system. Together, the project tile 452, property tile 454, and task tile 456 provide functions of the design interface. Tile 458 provides the mechanical interface.

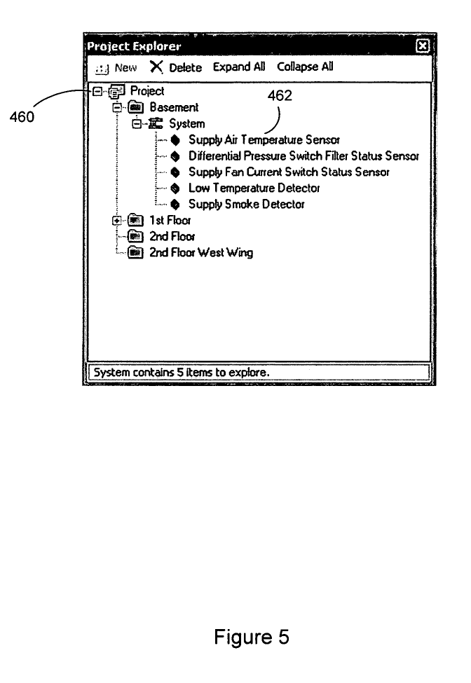

FIG. 5 illustrates an example of the project tile 452. The project tile 452 is configured to provide information related to a project for a building automation system. The information is displayed as a tree diagram 460 showing relationships of areas of a project and the components for configured systems. A project may include multiple dependent or independent configurable building automation systems. For example, a project is designed for providing an environmental control system for a multi-level building. Each level may have an environmental control system that is configured using the configurator. Together, the control systems for each floor provide the environmental control system for the entire building. The project tile 452 illustrates a tree diagram 460 showing the relationship of the various configured areas. The project tile 452 includes the user name and the project and the component areas of the project. As a characteristic for a feature is selected, one or more components configured to implement the selected characteristic are identified. The components may be identified according to engineering parameters and/or specifications for the component or components. As the feature characteristics are selected and the corresponding components identified, a list 462 of the identified components for the area being configured is populated under a corresponding design area in the tree diagram.

The project tile 452 permits a user to create, store, and retrieve files related to a control system. Each file relates to at least a portion of a control system, such as a different floor of a building, and is visually represented by an area icon 461 and associated text in the tree diagram 460. Additionally, components for an area are listed in the list 462 and visually represented by a feature icon 463 and associated text.

The project tile 452 may have a menu 459 having a number of selectable routines. The menu 459 may be displayed as a horizontal tile at the top of the project tile 452. The menu 459 also may be displayed as shown in FIG. 5. The menu 459 may provide access to a “New” routine which creates files, a “Delete” routine which deletes files, an “Expand All” routine for displaying the tree diagram 460 associated with a control system, and a “Collapse All” routine for collapsing or removing the tree diagram 460 associated with a control system. Additional, different, or fewer routines may be provided.

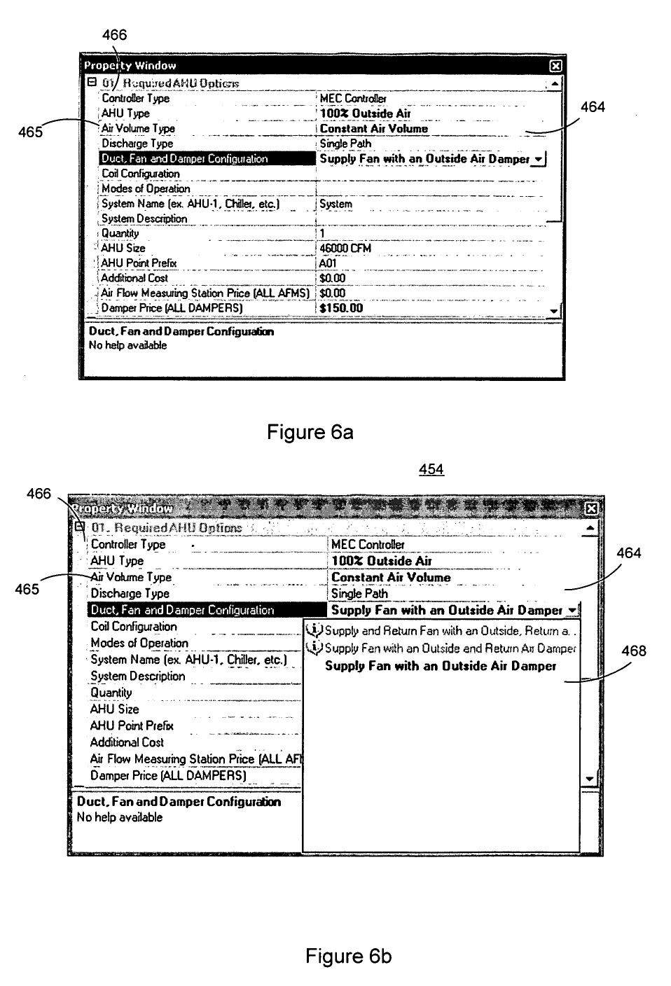

FIGS. 6a and 6b illustrate an example of a property tile 454 of the configurator 200. The property tile 454 provides an interface for a user to make selections for characteristics of features for a desired building control system. In an embodiment for configuring a building environment control system, the property tile 454 displays selectable or configurable features 465 with corresponding selections 464, where previously made. For example, the selectable features for the environmental control system include options for air handling unit (AHU), supply fan options, return fan options, damper options, coil options auxiliary Equipment options, control strategy options, smoke detector options, wiring options, monitoring options and any other options that may be considered for configuring a building automation system. The property tile 454 also provides an area where notes related to the system are recorded. Each of the options may be expanded to include sub-options for selecting specific features for the option. In the example of the property tile 454 of FIG. 6a, a sub-folder for selectable features or options for an air handling unit is shown.

An example of selection of features is illustrated in part by FIGS. 6a and 6b. Mechanical equipment components of a control system may be identified by selecting features related to mechanical equipment components. From the selection of mechanical components, one or more control strategies for the control system are identified and sensors and other end devices are automatically selected are automatically determined according to the equipment and control strategies. The sensors and other end devices also may appear in the project window for further configuration of the default options. The identified options for control strategies and end devices may be also be changed to configure the system.

In general, the list of items in the project window are configurable from list of options that are refined based on other previous selected options. For example, options may become available or unavailable after the selection of other options. Each option list may distinguish available options from unavailable options or remove the unavailable options from the option list. Additionally, the defaults for several predefined options may be changed on a global basis prior to beginning the process of configuring a building control system.

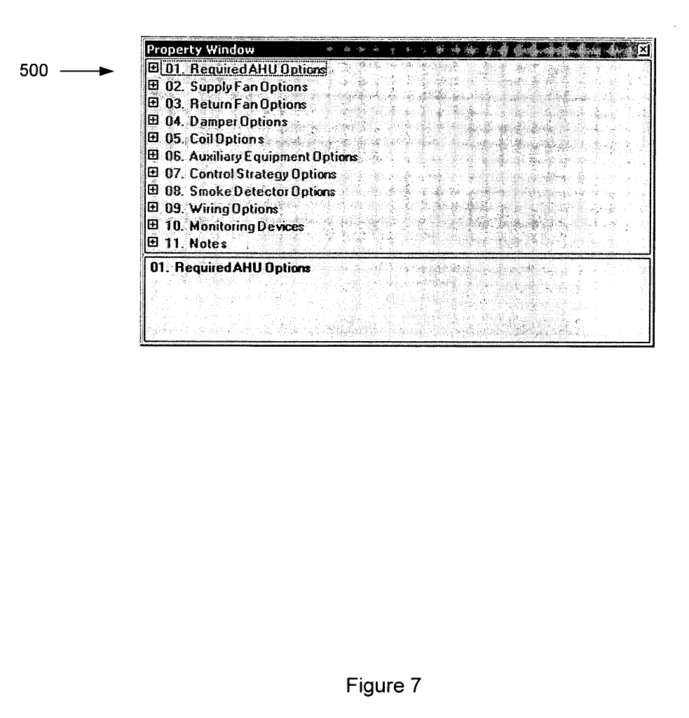

FIG. 7 illustrates an example of areas of a HVAC control system that may be configured. Each area or portion is identified with a selection button or segment bar 500. Activation of a segment bar 500 may provide access to a drop down or expandable list 466 of selectable features 465 of the control system, as noted above for FIGS. 6a and 6b. In the example of the property tile 454 of FIG. 7, the segment bars 500 provide access to expandable lists 466 for air handling unit (AHU) options, supply fan options, return fan options, damper options, coil options, auxiliary equipment options, control strategy options, smoke detector options, wiring options, and monitoring devices. A bar 500 also provides access to an area for recording system related notes. Additional, different, or fewer options may be provided. The same or different lists of options are provided for other types of building control systems.

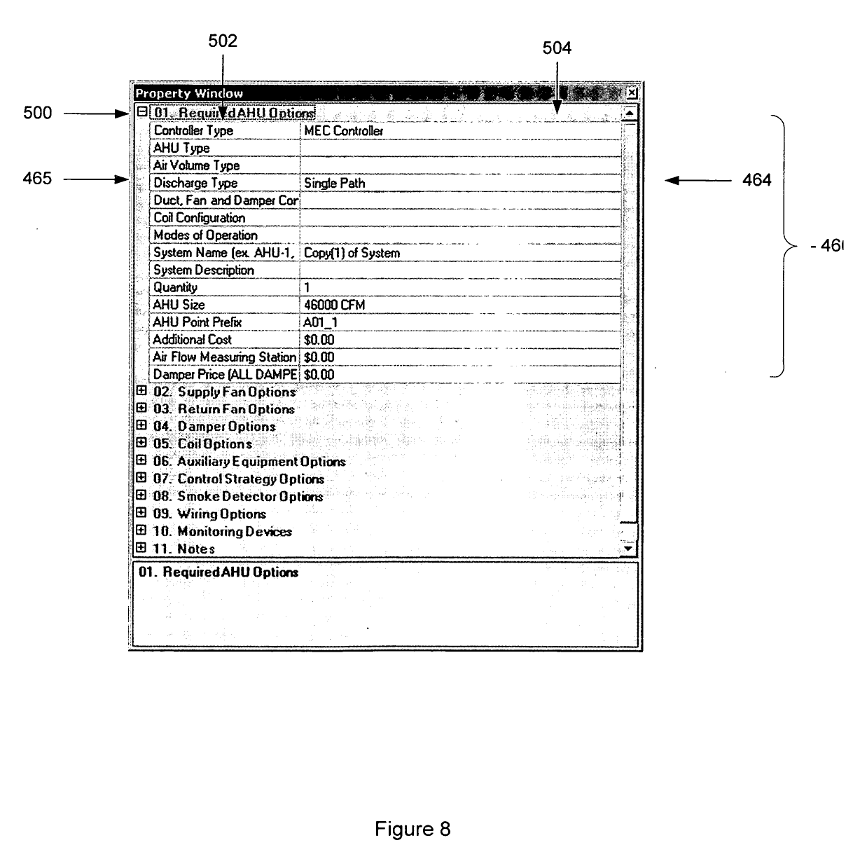

Each expandable list 466 may be displayed by moving a cursor illustrated on a display screen by a mouse or other input device over the corresponding segment bar 500 and clicking on the segment bar 500 or other user selection icon. For example, by clicking on the “Required AHU Options” segment bar 500 shown in FIG. 7, the expandable list 466 corresponding to the “Required AHU Options” is displayed, as shown in FIG. 8.

The property tile 454 presents the selection of the features 462 or properties according to predetermined rules. The rules establish a general hierarchy by which selections of features of the system are chosen. The hierarchy logically guides the user through the selection of features to ensure a building automation system having necessary components is configured. In an embodiment, the property tile 454 provides a list of common features for all building automation system for the type of system being configured. In the environmental control system embodiment, the property tile 454 includes an expandable list 466 for air handling unit (AHU) options, as shown in FIGS. 6a and 6b. The expandable list 466 includes a set of features that must be identified to configure an environmental control system. For example, the list 466 includes selections for AHU type, controller type, air volume type, discharge type, duct, fan and damper configuration, coil configuration, modes of operation, system name, system description, AHU size, and AHU point prefix. The list 466 also includes information related to additional costs, air flow measuring station price, damper prices, and any other information that is specified for the environmental control system.

FIG. 6a illustrates a selection for a particular feature. For a desired feature, the user moves a cursor to a desired point on the list 466 where a selection of a feature is desired. The user also may choose a feature to configure using a keyboard of the processor. When the feature is identified, a set of possible choices or alternatives are identified and presented in a pop-up tile 468. The choices are identified and presented based on previously selected features or features which have not yet been selected, and engineering parameters for the feature. For example, a system may be configured by selecting an AHU type from a list of choices. Similarly, when an AHU type has been selected, other parameters or features of the system may be made. The user, for example, moves or otherwise places a cursor over another feature, such as “duct, fan and damper configuration” and “clicking” on the area to indicate that the user desires to view alternatives for the feature. In response to the user's clicking on the area, the pop-up tile 468 opens with selectable options for the feature. In the AHU example, the user is presented with options for selecting a mixed air handler, or a 100% outside air handler. In the example shown in FIG. 6a, a pop up tile for the “duct, fan and damper configuration” feature is open and showing available options based on selections made for other features. When a selection is made, the pop-up tile collapses and the corresponding selection is displayed relative to the feature.

Data associated with a choice for a feature also is used to identify corresponding components from the database 204. When a selection for a feature is made, the database 204 is queried to determine required components configured to provide the selected feature. Data associated with the identified components populate a data set of selected features and/or components. For example, a selection for a 100% outside air AHU may identify an appropriate supply air temperature sensor and differential pressure switch filter status sensor to implement such a feature. The selection of a variable air volume also identifies an appropriate low temperature detector, supply smoke detector and supply air static pressure sensor to implement the variable air volume feature. Data associated with each of the identified features and/or components from the database 204 is used to populate a data set for the configured system. The data set is stored in the database 204 or other appropriate storage medium. In addition, a list of identified components may be displayed under a corresponding branch of the tree diagram displayed in the project tile.

Alternatives for features that depend on the prior selection of other features may not be chosen until the prior selection is made. Similarly, options for a feature that are not appropriate for a feature based on prior selections may not be made available. The configurator tracks the selections made and determines which selections are available for each selectable feature. When the feature is identified for a selection, (e.g., the user clicks on the area), the pop up tile 468 displays the appropriate selections. For example, the options for the type of duct, fan and damper configuration may not be made until an AHU type is made. The available options for a feature may be determined according to selections made for prior features. When the user clicks on a feature that requires a prior selection, the options for the feature may be displayed, but a selection may not be made.

When a feature is selected, the selection is displayed and options for other features also are determined. The options are determined according to engineering rules or parameters that define the relationship of the features and corresponding components. The configurator is adapted to control the choices based on the engineering criteria for the building automation system being configured and the parameters of the components that make up a configurable system. For example, when the AHU is configured as a 100% outside air unit, the selection for duct, fan and damper configuration will be limited to a supply fan with an outside damper, as shown in FIG. 6b, because other components for this feature would not be desirable based on the selected AHU. When a mixed AHU has been designated, the selection for duct, fan and damper include options for a supply fan with an outside return air damper. The user continues to click and select until all required selections for some, all, or substantially all required feature have been chosen. Similarly, when a feature or combination of features has been selected, any feature for which an option is no longer available because of the prior selection are automatically determined by the Configurator.

When the components have been identified, an option list for the component (not shown) may be expanded to allow the input of component specific information. For example, where a system has been configured with a supply fan, a supply fan options list is expanded to allow the user to make selections appropriate for available supply fans for the configured system. The available supply fans may be identified according to the choices of the selected feature. The supply fan options may include the volume control, fan type, fan status, fan actuation type, fan backdraft damper options, and supply fan output range. Similarly, expanded options list provide for return fans, dampers, coils, auxiliary equipment, wiring, control strategies, smoke detector or any other component of the configured system.

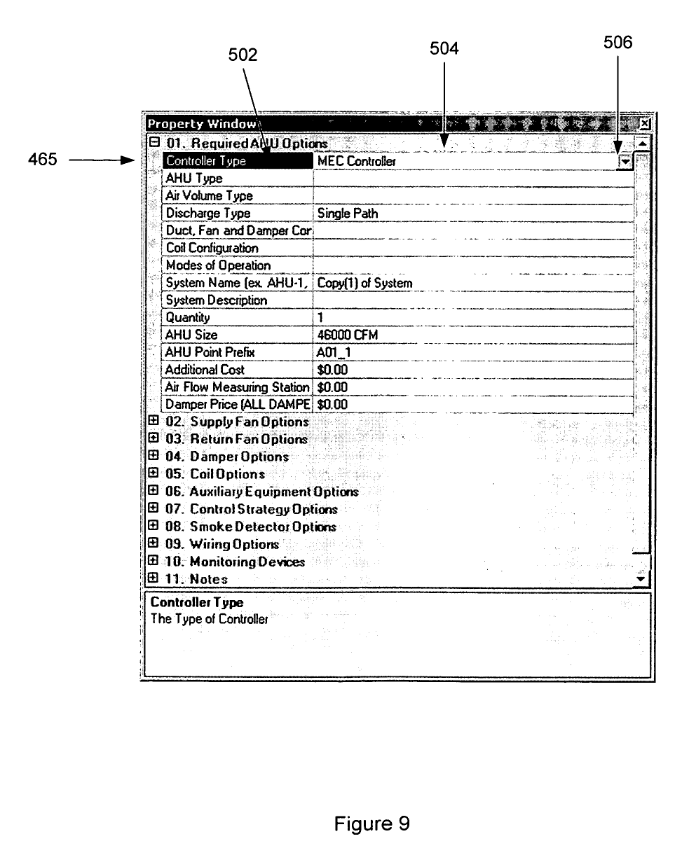

FIGS. 8 and 9 illustrate that a selectable or configurable feature 465, such as “Controller Type,” in the feature list 502 may be highlighted by moving a cursor over the feature 465 and clicking on the feature 465. By highlighting the selectable feature 465, an option list icon 506 appears within the selection list 504 if there is a list of options available for selection corresponding to the selectable feature 465.

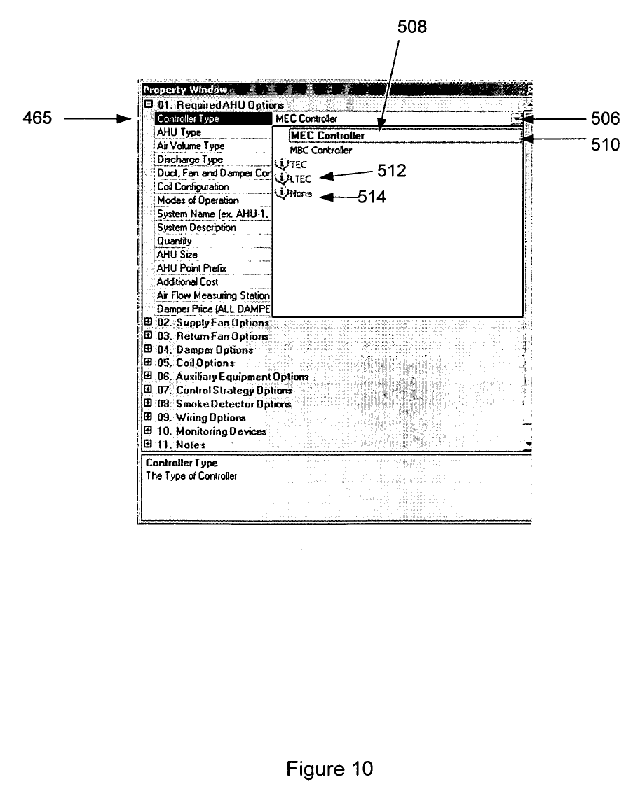

FIG. 10 illustrates that by clicking on the option list icon 506, a pop-up tile 468 that includes an option list 508 appears. The option list 508 includes possible options for the corresponding selectable feature 465. The option list 506 may include options currently available for selection 510 and options currently not available for selection 512. The options currently available for selection 510 may be distinguished from the options currently not available for selection 512. For example, the options currently available for selection 510 may be emphasized and/or the options currently not available for selection 512 may be deemphasized. Additionally, if there is more than one option currently available for selection 510, such as the “MEC Controller” and the “MBC Controller” options of the example shown in FIG. 10, the option currently selected (“MEC Controller” in this case) may be distinguished from the other options currently available for selection. The options currently not available for selection 512 may have a corresponding information icon 514.

After an option currently available for selection 512 is selected from the option list 508, such as by moving a cursor over and clicking upon the option currently available for selection 512 listed in the option list 508, the selection list 504 displayed in FIG. 9 is updated to include the option selected. The selections 464 listed in the selection list 504 that are user-selected selections may be emphasized or otherwise distinguished from other selections 464 listed in the selection list 504.

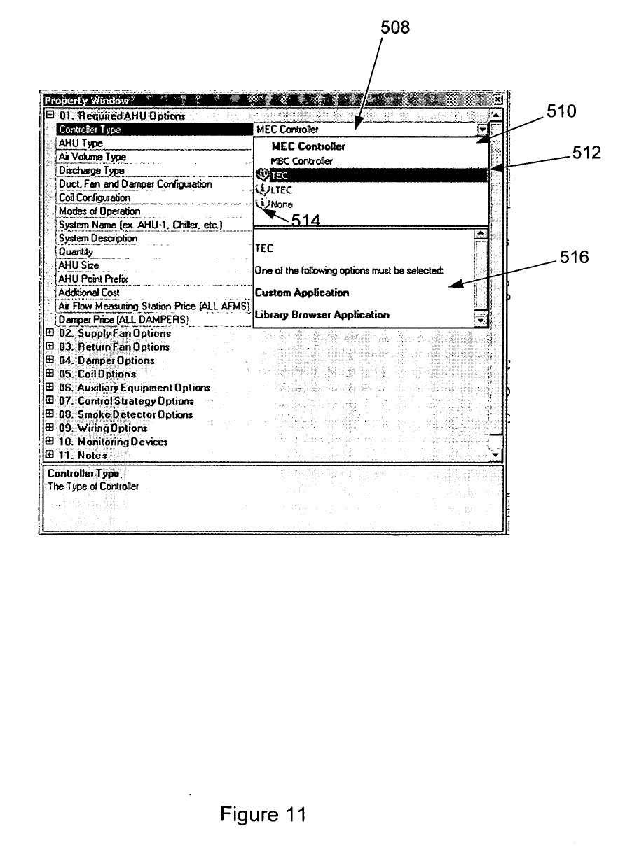

FIG. 11 illustrates that, by clicking upon an option currently not available for selection 512 listed in the option list 508, the option currently not available for selection 512 may be highlighted. Additionally, by clicking upon an option currently not available for selection 512 having a corresponding information icon 514, a message box 516 may appear. The message box 516 may provide information pertaining to the unavailability of the option listed in the option list 508. For the example illustrated in FIG. 11, either the “Custom Application” or the “Library Browser Application” option must be selected before the “TEC” option may become an option currently available for selection 510.

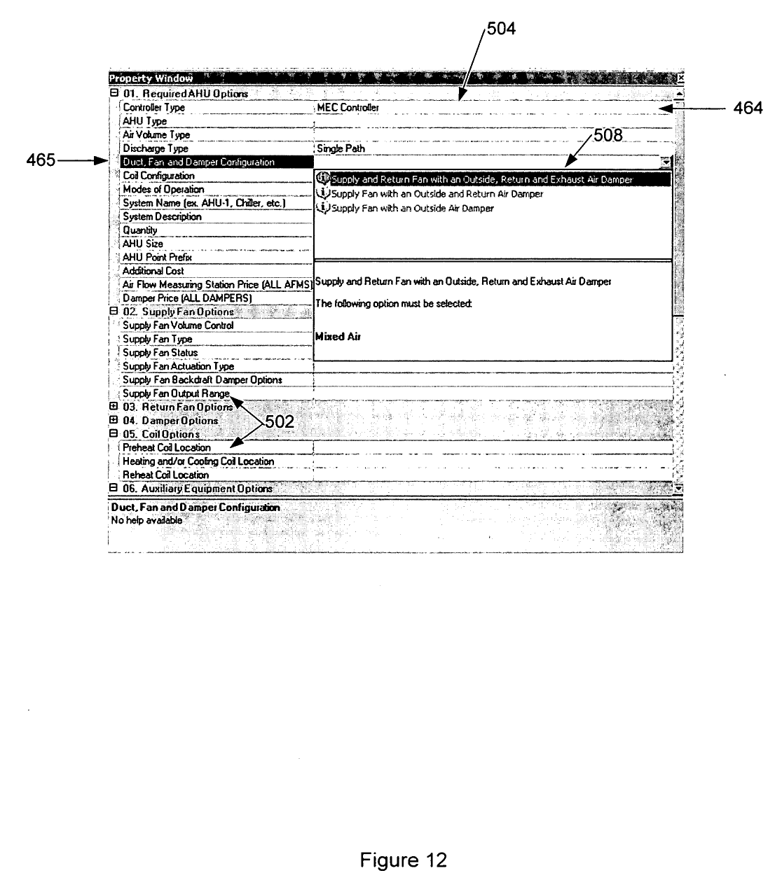

FIG. 12 illustrates that an option list 508 for a corresponding selectable feature 465, such as for the “Duct, Fan, and Damper Configuration” selectable feature 465, may not have any options currently available for selection based upon the selections 464 currently listed in the selection list 504. FIG. 12 also illustrates the feature lists 502 corresponding to other expandable lists, such as the “Supply Fan Options” and the “Coil Options” expandable lists, may be simultaneously displayed.

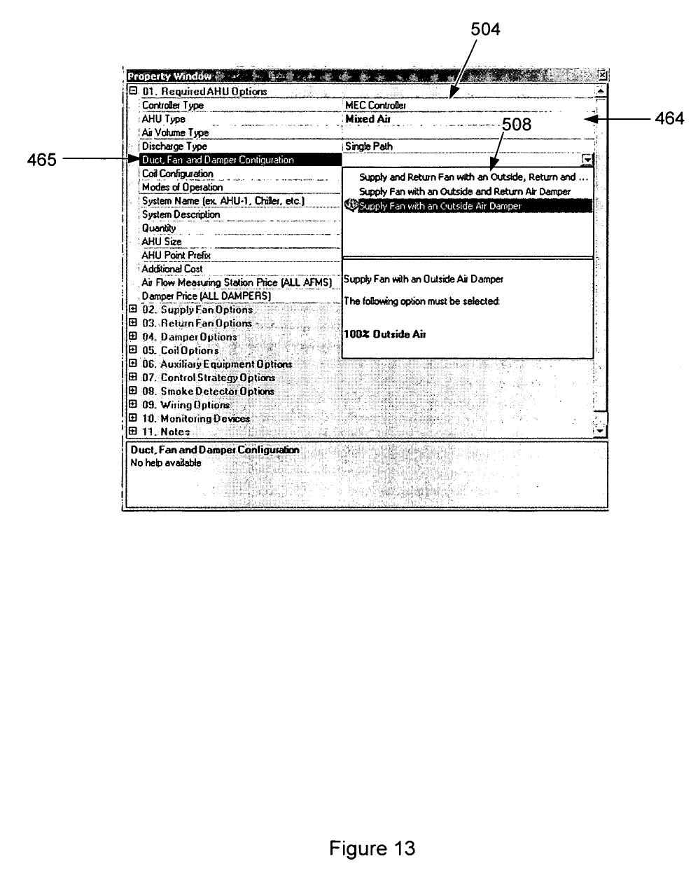

FIG. 13 illustrates that an option list 508 may be updated or revised to reflect which options for a selectable feature 465 are available for selection based upon the other selections 464 currently listed in the selection list 504. Specifically, the example shown in FIG. 13 demonstrates that the “Mixed Air” option has been selected for the “AHU type” selectable feature 465. As a result, the option list 508 corresponding to the “Duct, Fan, and Damper Configuration” selectable feature 465 has been updated to reflect that the upper two options in the option list 508 are now available for selection based upon the currently selected options listed in the selection list 504. Specifically, for the example shown, information icons corresponding to the upper two options in the option list 508 are no longer displayed, and the text associated with the upper two options is distinguished from the text of the lower option in the option list 508 that remains currently not available for selection.

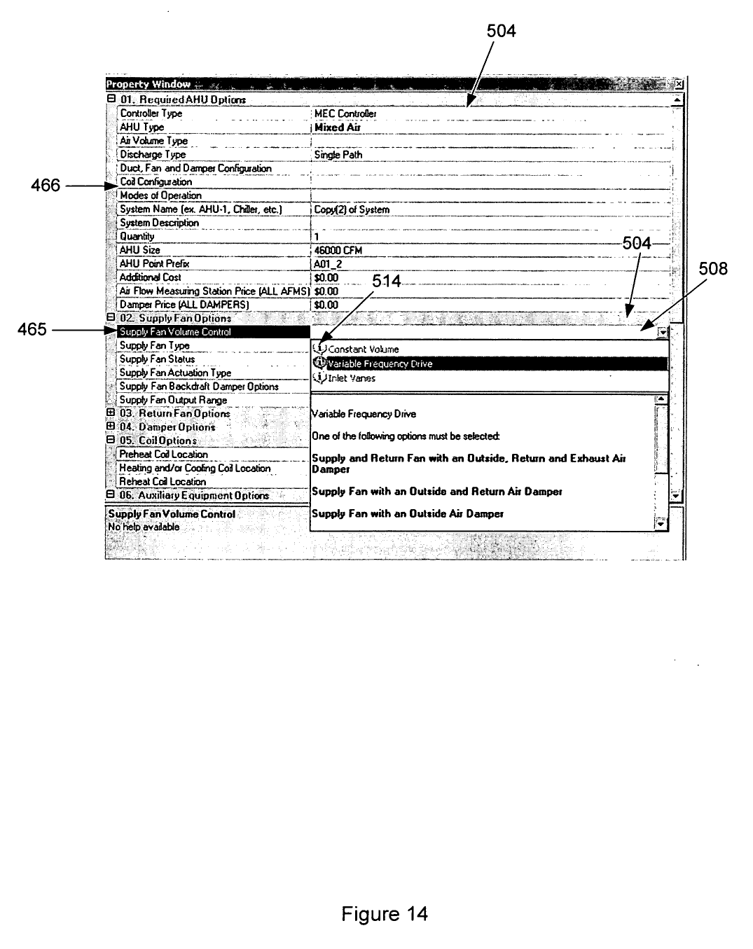

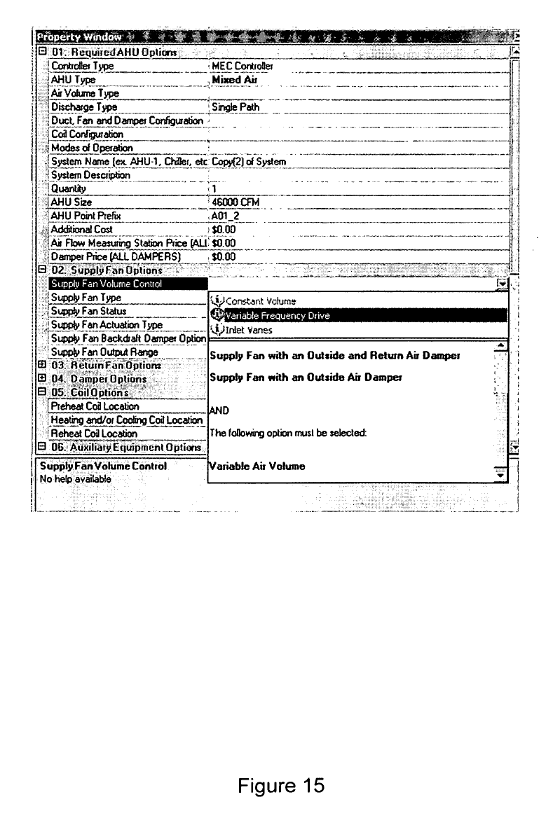

FIGS. 14 and 15 illustrate another example of a selectable feature 465 not having any options currently available for selection based upon the options currently selected and listed within the selection lists 504 of the expandable lists 466. In the example shown, no options in the option list 508 corresponding to the “Supply Fan Volume Control” selectable feature 465 are currently available for selection. However, for each option listed in the option list 508, a text message regarding the unavailability of the option may be accessed by highlighting the corresponding information icon 514. For example, for the “Variable Frequency Drive” option to become available for selection, either the “Supply and Return Fan with an Outside, Return, and Exhaust Air Damper,” the “Supply Fan with an Outside and Return Air Damper,” or the “Supply Fan with an Outside Air Damper” option must be selected and the “Variable Air Volume” option must be selected.

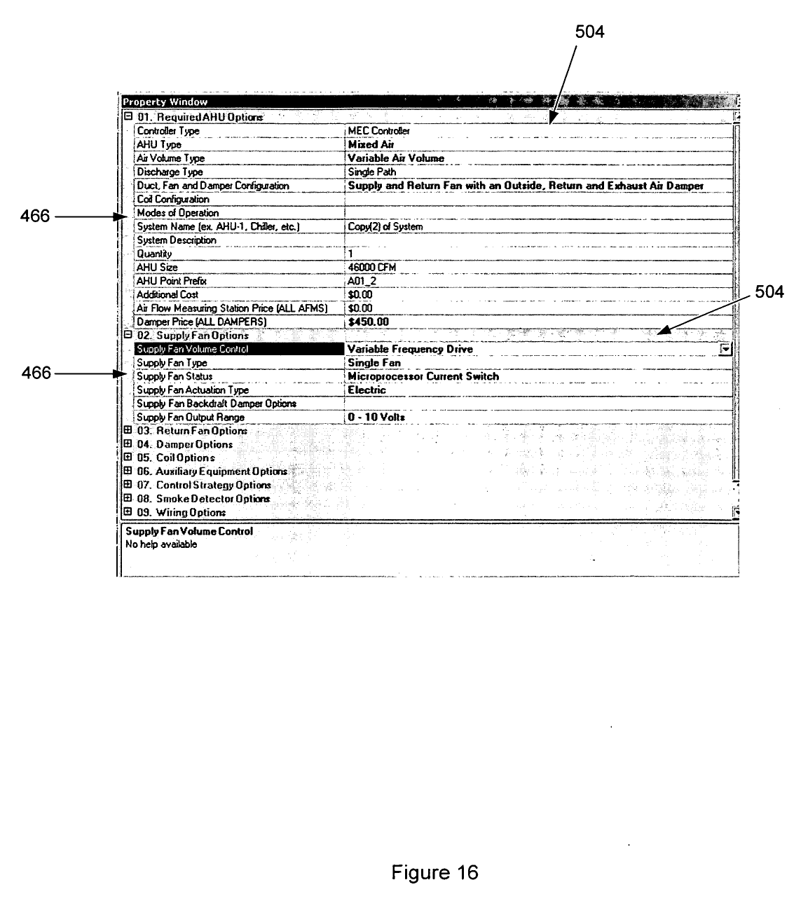

FIG. 16 illustrates that after the “Variable Air Volume” and the “Supply and Return Fan with an Outside, Return and Exhaust Air” options have been selected in the selection list 504 corresponding to the “Required AHU Options” expandable list 466, the selection list 504 corresponding to the “Supply Fan Options” expandable list 466 is automatically updated with a plurality of options available based upon the options currently selected. Specifically, with the “MEC Controller,” the “Mixed Air,” the “Variable Air Volume,” and the “Supply and Return Fan with an Outside, Return and Exhaust Air” options selected, the “Supply Fan Options” may include the “Variable Frequency Drive,” the “Single Fan,” the “Microprocessor Current Switch,” the “Electric,” and the “0-10 Volts” options.

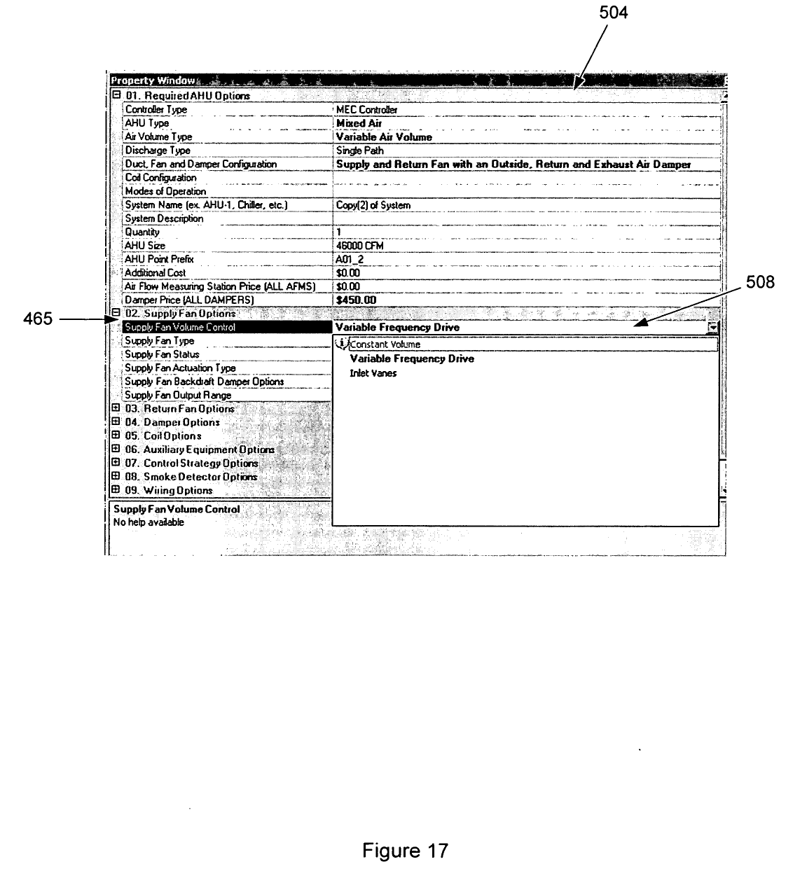

FIG. 17 illustrates that for the “Supply Fan Volume Control” selectable feature 465, with the options currently selected and listed in the selection lists 504, the corresponding option list 508 contains three options. The deemphasized “Constant Volume” option is currently not available for selection, while the “Variable Frequency Drive” and the “Inlet Vanes” options are currently available for selection based upon the options currently selected. The “Variable Frequency Drive” option is highlighted to emphasize that it is an option currently selected.

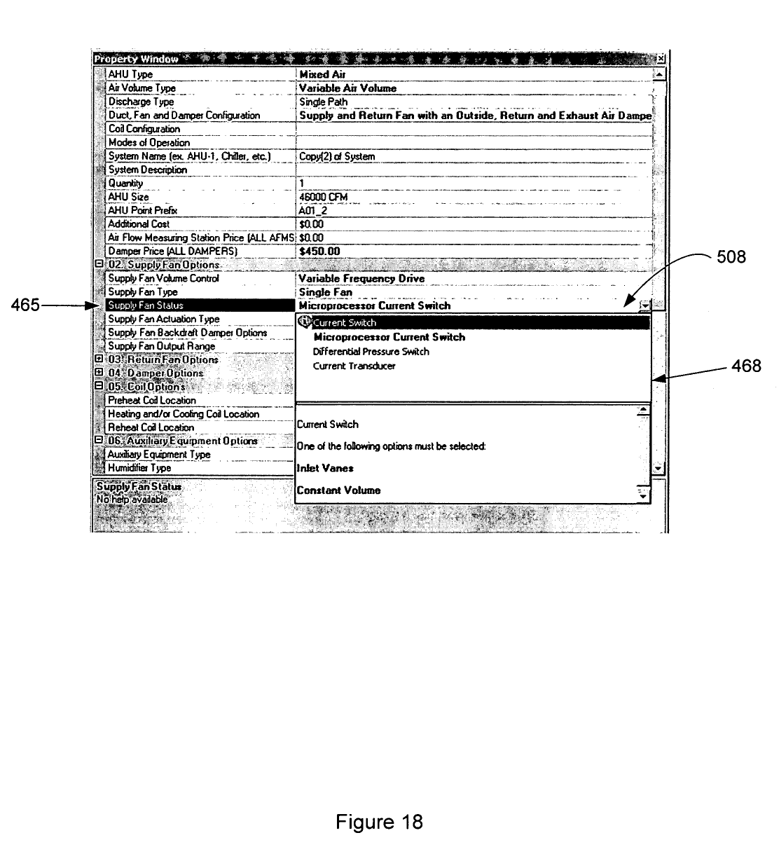

FIG. 18 illustrates an option list 508 for the “Supply Fan Status” selectable feature 465 based upon the options currently selected. The pop-up tile 468 informs the user that for the “Current Switch” to become an option available for selection, either the “Inlet Vanes” or the “Constant Volume” option must be selected.

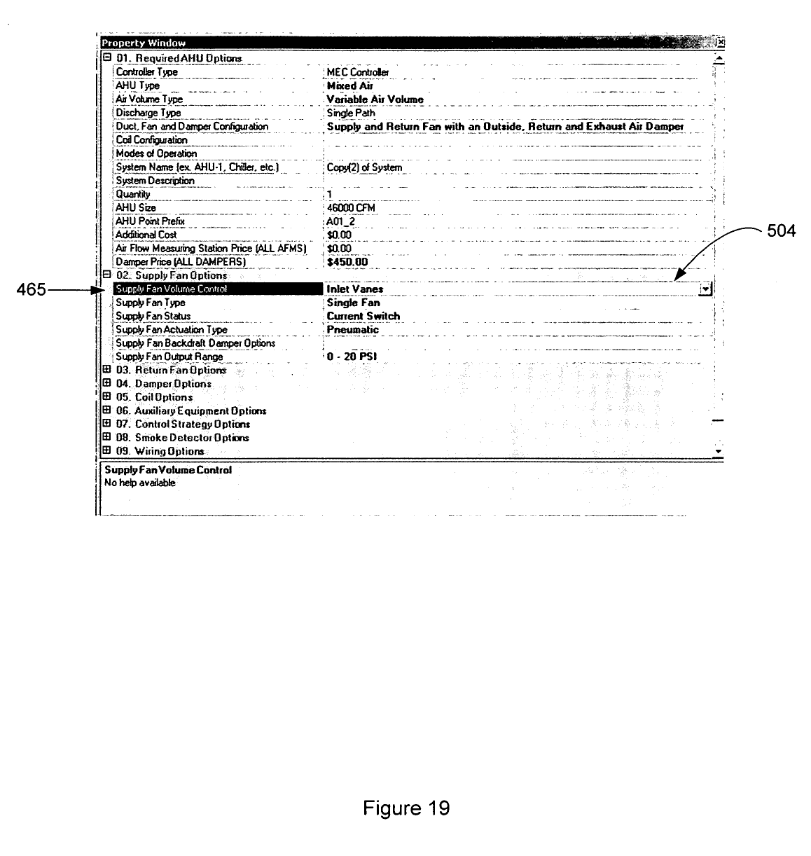

FIG. 19 illustrates that upon the selection of the “Inlet Vanes” option from the option list corresponding to the “Supply Fan Volume Control” selectable feature 465, a number of options listed in the “Supply Fan Options” selection list 504 are automatically changed to reflect that certain options are not mutually available with the “Inlet Vanes” option. Specifically, the options corresponding to the “Supply Fan Status,” the “Supply Fan Actuation Type,” and the “Supply Fan Output Range” selectable features 465 are automatically changed to “Current Switch,” “Pneumatic,” and “0-20 PSI” upon the selection of the “Inlet Vanes” option.

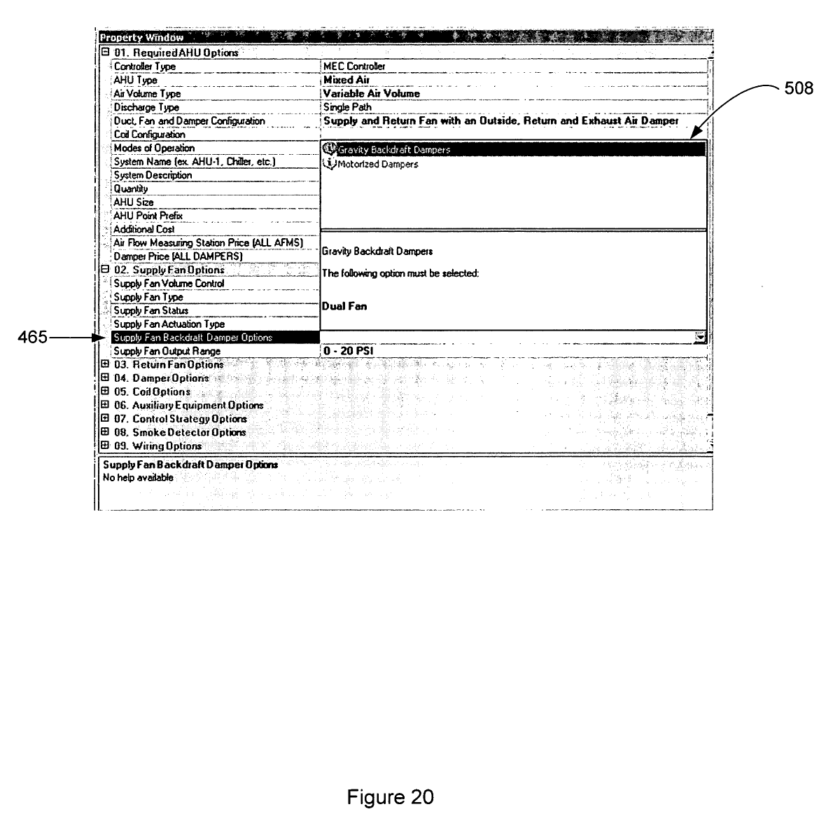

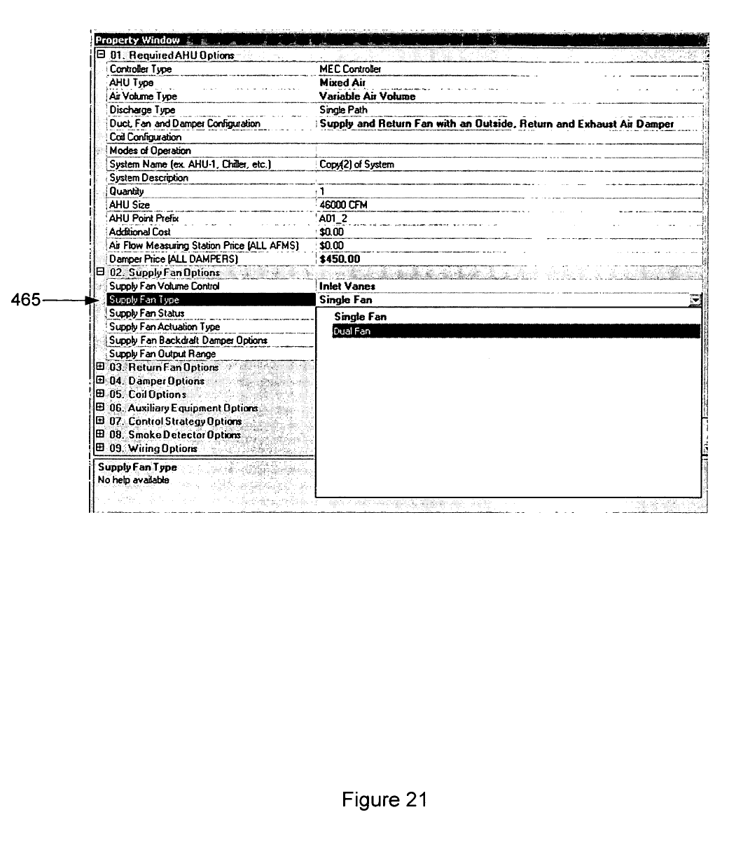

FIG. 20 illustrates an option list 508 for the “Supply Fan Backdraft Damper Options” selectable feature 465. As the example of FIG. 20 demonstrates, both the “Gravity Backdraft Dampers” and “Motorized Dampers” options listed in the option list 508 are not available for selection based upon the options currently selected. However, FIG. 21 illustrates the selection of the “Dual Fan” option for the “Supply Fan Type” selectable feature 465.

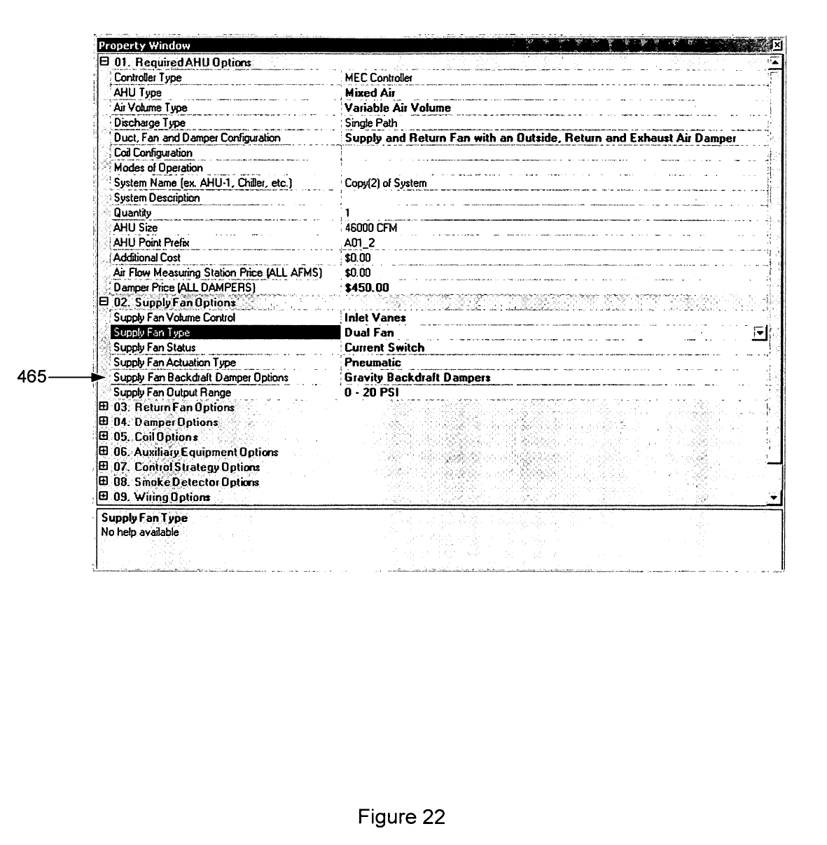

After the selection of the “Dual Fan” option, the “Gravity Backdraft Dampers” option is automatically selected for the “Supply Fan Backdraft Damper Options” selectable feature 465, as illustrated in FIG. 22. The “Motorized Dampers” option listed in the options list 508 for the “Supply Fan Backdraft Damper Options” selectable feature 465, as shown previously in FIG. 20, is also now an option available for selection based upon the options currently selected and may be selected by a user.

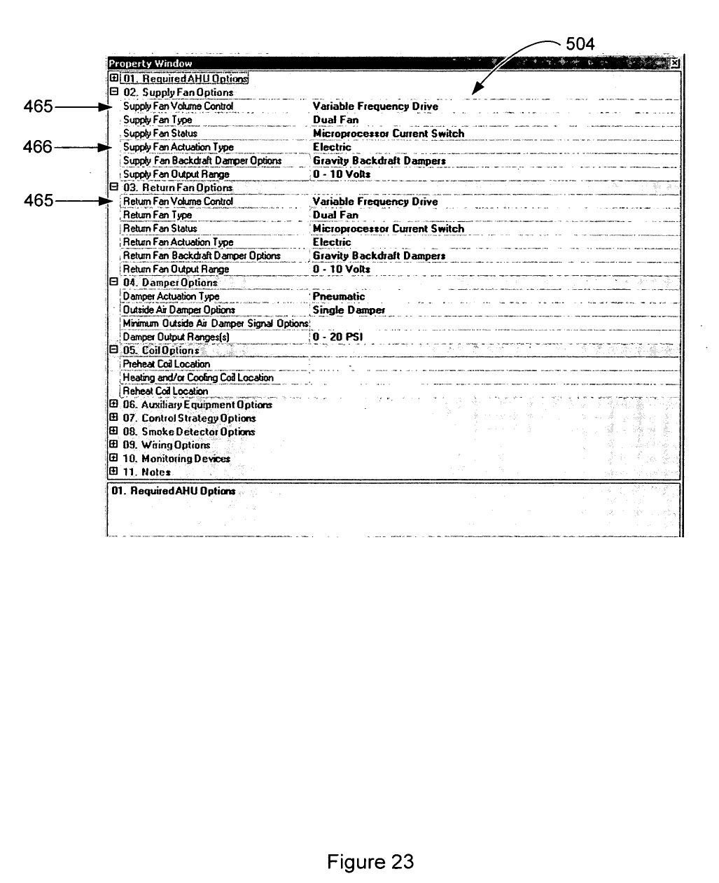

FIG. 23 illustrates the selectable features 465 for the “Supply Fan Options,” the “Return Fan Options,” the “Damper Options,” and the “Coil Options” expandable lists 466. As shown, the options selected for the “Return Fan Options” expandable list 466 may initially be automatically set the same as the options listed in the selection list 504 corresponding to the “Supply Fan Options” selectable features 465. However, the options for the “Return Fan Options” selectable features 465 may subsequently be changed by a user to be different than the options selected for the “Supply Fan Options” selectable features 465.

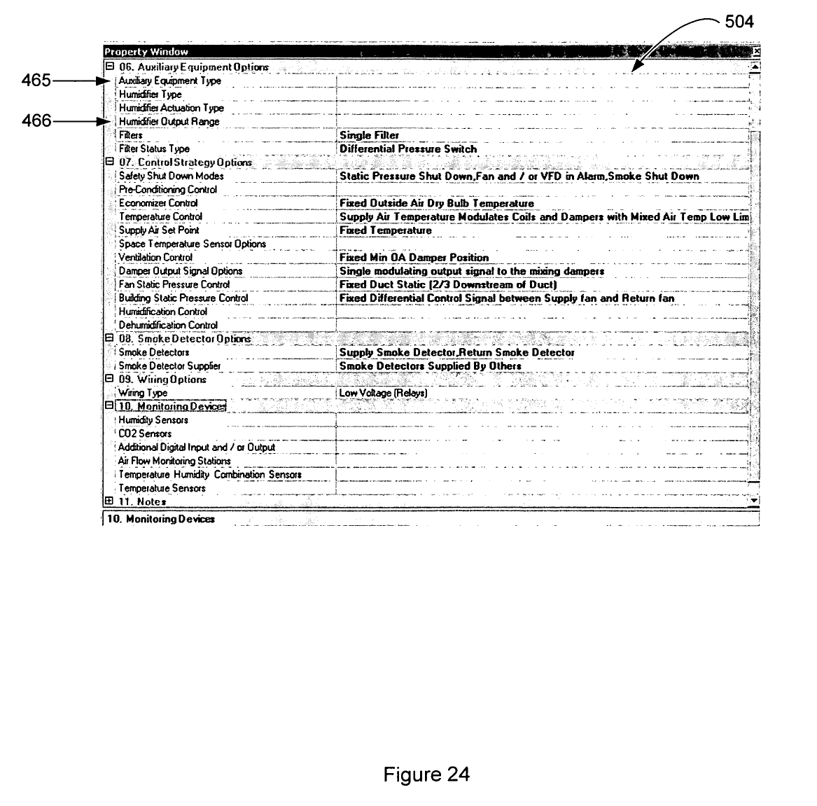

FIG. 24 illustrates the selectable features 465 for the “Auxiliary Equipment Options,” the “Control Strategy Options,” the “Smoke Detector Options,” the “Wiring Options,” and the “Monitoring Devices” expandable lists 466. As shown, a plurality of the options listed in the respective selection lists 504 may be automatically selected based upon other options selected. However, the options automatically selected based upon other options selected may be subsequently changed utilizing corresponding options lists, as discussed above.

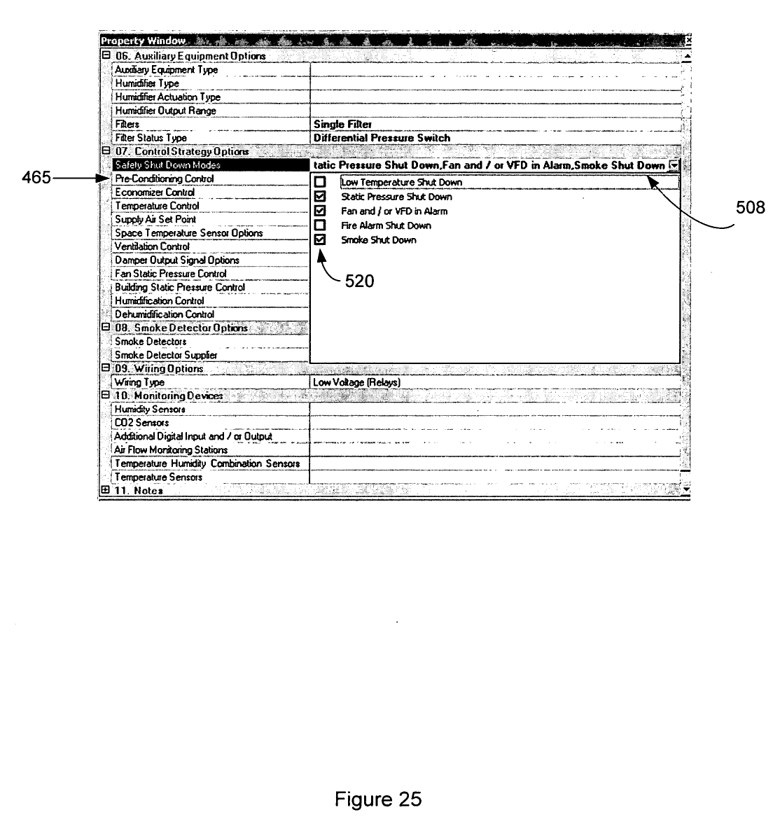

FIG. 25 illustrates an option list 508 corresponding to the “Safety Shut Down Modes” selectable feature 465. The option list 508 includes a number of options that may be combined with other options, as indicated by box icons 520. Specifically, the options available for the example shown include the “Low Temperature Shut Down,” the “Static Pressure Shut Down,” the “Fan and/or VFD in Alarm,” the “Fire Alarm Shut Down,” and the “Smoke Shut Down” options. Each option selected is indicated by a check mark being displayed within the corresponding box icon 520. As shown, the “Static Pressure Shut Down,” the “Fan and/or VFD in Alarm,” and the “Smoke Shut Down” options have been selected.

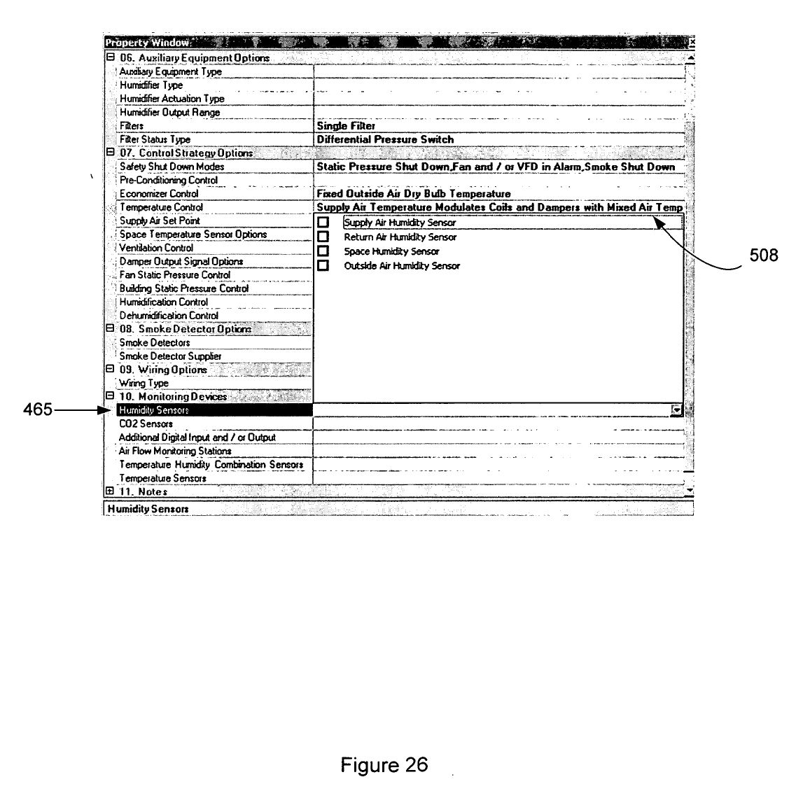

FIG. 26 illustrates an option list 508 corresponding to the “Humidity Sensors” selectable feature 465. Again, the option list 508 includes a plurality of options available for selection and combination. Specifically, for the example shown, the “Supply Air Humidity Sensor,” the “Return Air Humidity Sensor,” the “Space Humidity Sensor,” and the “Outside Air Humidity Sensor” options are available. However, as illustrated, none of the available options have been automatically selected based upon other options selected.

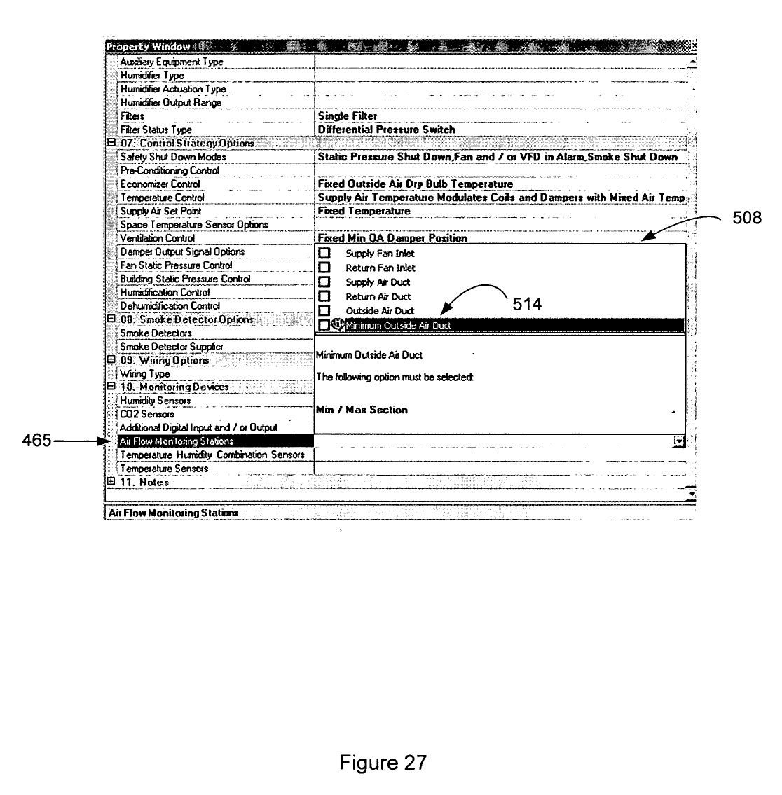

FIG. 27 illustrates an option list 508 corresponding to the “Air Flow Monitoring Stations” selectable feature 465. Again, a number of options are available for selection and combination. Specifically, for the example illustrated in FIG. 27, the “Supply Fan Inlet,” the “Return Fan Inlet,” the “Supply Air Duct,” the “Return Air Duct,” and the “Outside Air Duct” options may be selected and combined. However, the “Minimum Outside Air Duct” option is currently not available for selection or combination. The unavailability of an option not currently available for selection or combination may be visually indicated by a corresponding information icon 514 or distinguishing text representing an option not currently available for selection or combination from the text representing options currently available.

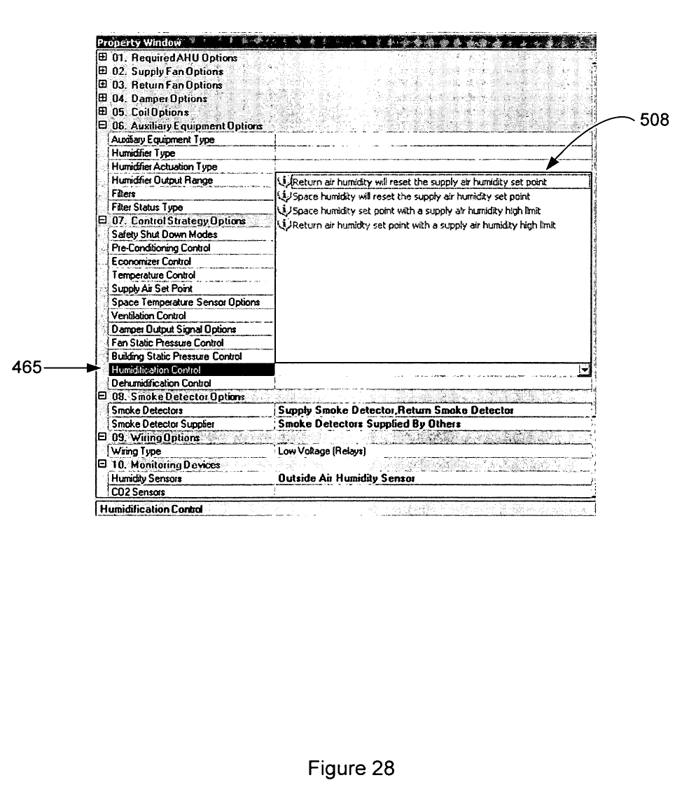

FIG. 28 illustrates that if a plurality of options are automatically selected for a number of corresponding selectable features 465, the selectable features 465 for which no option was automatically selected may be associated with options listed in the corresponding option list 508 that are currently not available. For the example shown in FIG. 28, the “Return air humidity will reset the supply air humidity set point,” the “Space humidity will reset the supply air humidity set point,” the “Space humidity set point with a supply air humidity high limit,” and the “Return air humidity set point with a supply air humidity high limit” options are currently not available for the “Humidification Control” selectable feature 465.

On the other hand, as shown in the example of FIG. 27, the selectable features 465 for which no option was automatically selected also may be associated with options listed in the corresponding option list 508 that are currently available. For the example illustrated, the “Supply Fan Inlet,” the “Return Fan Inlet,” the “Supply Air Duct,” the “Return Air Duct,” and the “Outside Air Duct” options are currently available for the “Air Flow Monitoring Stations” selectable feature 465 but none were automatically selected.

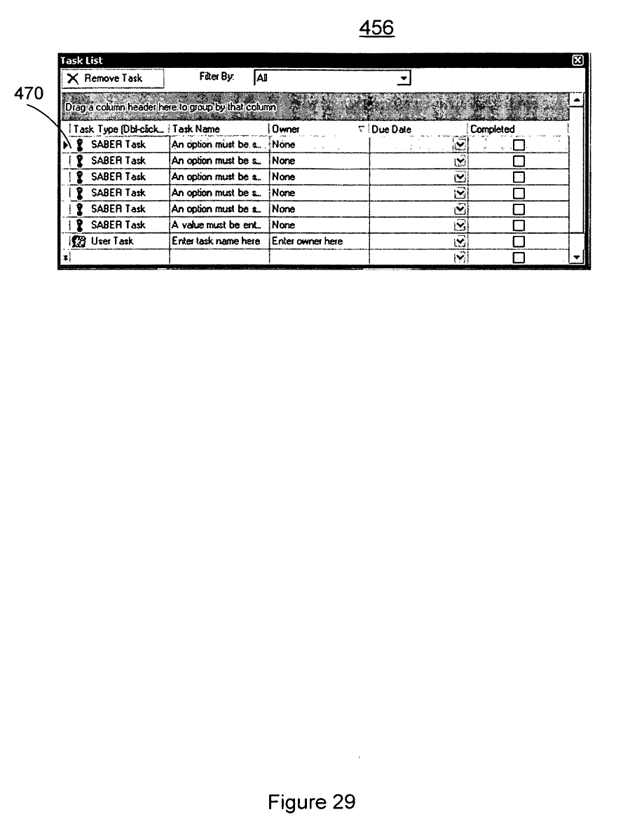

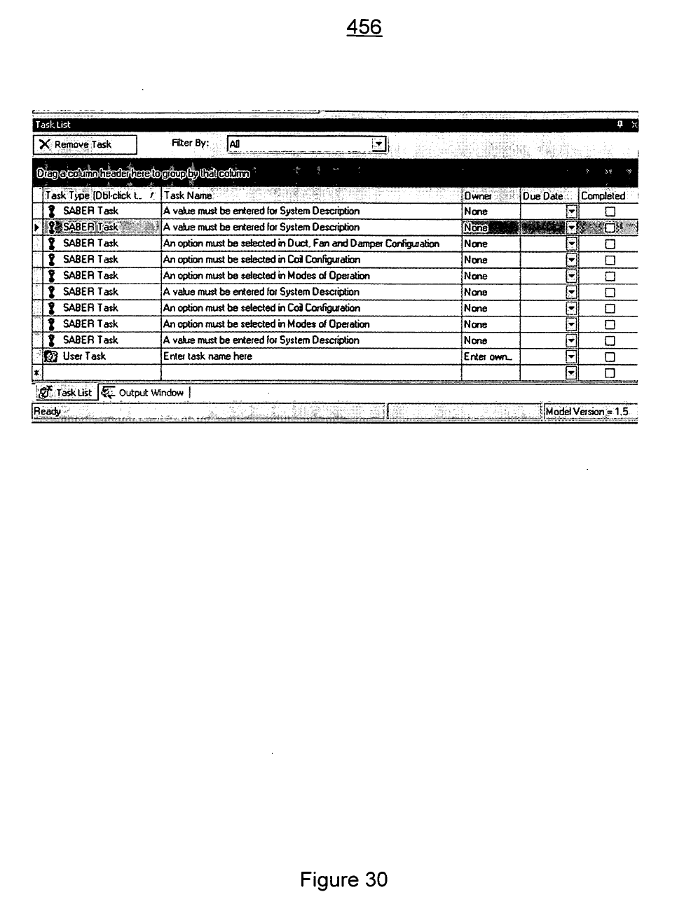

FIG. 29 illustrates an example of a task tile of the configurator 200. The task tile 456 identifies tasks needing completion for a configured building automation system. The task tile 456 displays a list 470 of tasks needing completion. The list 470 includes the task type, task name, an owner of the task, a due date, a status of the task. The information for a task in the task list may be automatically generated by the configurator 200. A user also my input information to the task list 470. A user may desire to start a project or area of a project, and yet not be able to identify all features for the system. The task tile 456 identifies the features for which a selection is required to identify all the components of a configured system. The task tile 456 automatically identifies outstanding items as the selections are made. An incomplete project may be saved before a system is completely configured. The task tile 456 provides a bookmark for the items that need to be completed when the project is opened. Similarly, since the task tile 456 identifies outstanding items while a system is being configured, the task tile 456 provides real-time information related the status of the system. The user or configurator 200 may remove a task, identify an owner of a task, identify a due date, and mark the task completed using the task tile 456. FIG. 30 further illustrates that the types of tasks may include reminders that values must be entered for certain fields or options selected for particular features. As an alternative to a separate tile, the tasks associated with features and options are highlighted in the property tile 454 and/or other tiles.

The above is only one example of the property tile 454. Many other systems, features, options, and components are possible. For example, the property tile 454 may provide for the sub-selection of either features or options, such as by accessible drill down screens. In one alternative for the expandable lists 466, each selectable feature 465 may have a corresponding pop-up window. Each of the options available also may have a corresponding detailed description or text message regarding that option. The automatic selection of features based upon options currently selected may be limited to certain selectable features 465 or areas of the control system, or expanded to include all selectable features 465. The property tile 454 also may be layered or designed to present selectable features 465 for which options are to be selected to the user in an order that results in enhanced convenience and efficiency. For example, the components or characteristics for which a number of other components or characteristics are dependent upon may be presented for selection first.

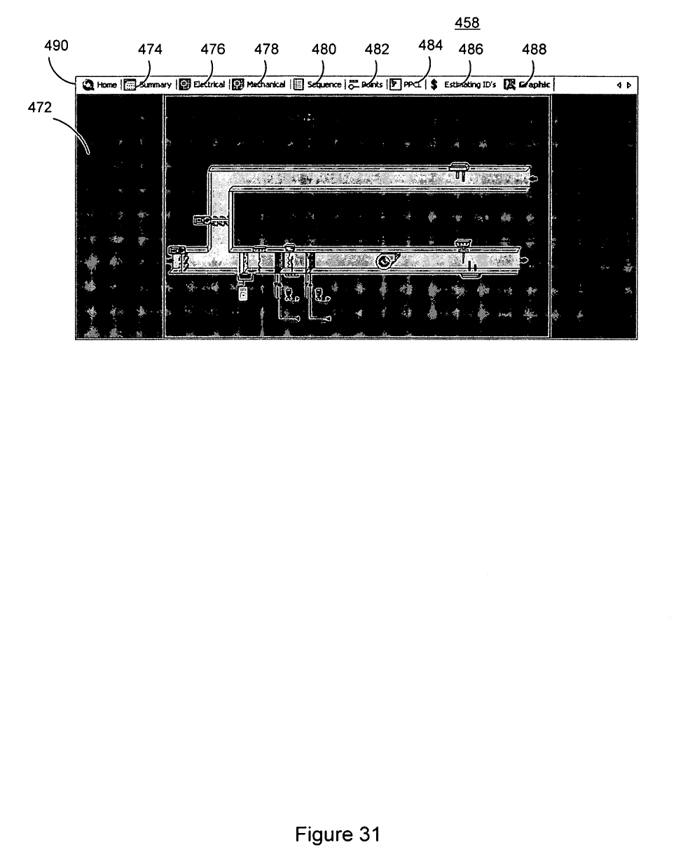

FIG. 31 illustrates an example of a mechanics interface tile 458 of the configurator 200. The mechanics tile 458 allows a user to generate output related to a configured system and/or project. The populated data set for the selected features and identified components is processed or filtered by data processing engines to generate reports, drawings, summaries, descriptions, figures, and like output. When a system has been configured, a user may invoke various engines to generate mechanical representations for the configured system. The mechanics interface tile 458 provides a tool bar 490 having one or more tabs or buttons 474-488, each corresponding to one of the engines of the configurator. In an embodiment, the configurator 200 includes an estimating engine, a price engine, point engine, an autocad engine, a sequence engine, a program engine, and a parts engine. The buttons buttons 474-488 of mechanics interface 458 allow the user to select an output to generate, including a summary 474, an electrical schematic diagram 476, a mechanical schematic diagram 478, a textual description 480, a list of control points 482, a program 484 for controlling a selected controller of the configured system, a list of estimating id's 486, and a graphic representation 488 of the configured system. When a tab or button is selected, the data in the populated data set is processed or filtered by the selected engine to provide the selected output on the tile 472.

The summary 474 provides general information or executive summary about the configured system. The electrical schematic 476 displays the electrical connections for the components of the system. The electrical schematic may be for example a CAD drawing of the electrical components of the configured system. The mechanical schematic 478 includes a mechanical layout or relative layout of the components and may be a CAD drawing. The sequence 480 or textual description provides a detailed written description for the configured system. The points 482 button generates and displays the control points for the system. The PPCL 484 selection generates the code for a controller of the system. The code may be generated according to the convention for programming the controllers of the configured system. The estimating ID button 486 provides a list of the components and the relative cost for the components. Finally, the graphic button 488 allows the user to generate an iconic of graphic representation for the configured system. The mechanical representations may be as described in copending applications filed on Feb. 1, 2005, entitled Building Control System Configurator, (attorney docket no. 2005P01573), and Empty Space Reduction to Compress Schematics (attorney docket no. 2005P01575US), each of which is incorporated by reference in its entirety herein.

A method of designing a control system via a user interface is also provided. The method may include displaying a feature list within an user interface on a display screen, the feature list including selectable features of a control system, and displaying an option list, the option list including the available options for a corresponding selectable feature, the available options include control system components or characteristics. The method also may include displaying a selected available option, generating a plurality of option lists corresponding to selectable features, and updating a plurality of the option lists to reflect which options are available for selection for the respective selectable features based upon the options and/or features currently selected.

The method may include generating at least one option list containing options that are currently available and not available for selection, the options currently available for selection may be distinguished on the display screen from the options currently not available for selection. Each option list may be displayed within a pop-up window, the pop-up window may include a text message providing information about the unavailability of an option currently not available for selection. Each option list may include options that are combinable such that a plurality of options listed in the option list may be currently selected at the same time.

The method also may include automatically selecting a plurality of options for selectable features. The automatically selected options may be for selectable features other than the feature for which the available option was selected. Additionally, the available options may include different types of electrical and mechanical components, including sensors, detectors, valves, ducts, dampers, coils, pumps, piping, chillers, boilers, and terminal equipment of the control system. A plurality of segment bars may be displayed, each segment bar corresponding to an area or a portion of the control system and providing access to a corresponding feature list.

The method may include displaying a project window as part of the user interface, the project window provides a view of the project structure for a particular project file and access to the system components to be configured. The method may further include displaying a task window as part of the user interface, the task window providing information pertaining to the status of a plurality of tasks associated with the control system.

While the invention has been described above by reference to various embodiments, it should be understood that many changes and modifications can be made without departing from the scope of the invention. For example, the configurator and its components are adapted for configuring industrial control equipment. Applying engineering principles for the industrial control equipment a configuration schema may be developed whereby a predetermined set of rules may be followed to guide a designer of an industrial control system through selectable features, to a configured industrial control system. Similarly, the configuration may be adapted to configure security and lighting systems. The configurator may be adapted to configure integrated systems where, for example, an environmental control system may be configured with a fire detection and prevention system for a building. The description and illustrations are by way of example only. Many more embodiments and implementations are possible within the scope of this invention and will be apparent to those of ordinary skill in the art. The various embodiments are not limited to the described environments, and have a wide variety of applications including integrated building control systems, environmental control, security detection, communications, industrial control, power distribution, and hazard reporting.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

I (we) claim:

1. A method of designing a control system via a user interface, the method comprising:
displaying a feature list within an user interface on a display screen, the feature list including selectable features of a building control system; and
displaying an option list, the option list including available options for a corresponding selectable feature, the available options include building control system components or characteristics.

2. The method of claim 1, comprising:
displaying an available option selected;
generating a plurality of option lists corresponding to selectable features; and
updating a plurality of the option lists to reflect which options are available for selection for the respective selectable features based upon the options currently selected.

3. The method of claim 2, wherein at least one option list includes options that are currently available and not available for selection, the options currently available for selection distinguished on the display screen from the options currently not available for selection.

4. The method of claim 3, wherein the option list is displayed within a pop-up window, the pop-up window includes a text message providing information about the unavailability of an option currently not available for selection.

5. The method of claim 1, wherein the option list includes options that are combinable such that a plurality of options listed in the option list may be currently selected.

6. The method of claim 1, comprising automatically selecting a plurality of options for selectable features based upon an available option selected.

7. The method of claim 1, wherein the available options include different types of electrical and mechanical components, including sensors, detectors, valves, ducts, and dampers, of the control system.

8. The method of claim 1, comprising displaying a plurality of segment bars, each segment bar corresponding to a portion of the control system, each segment bar providing access to a corresponding feature list.

9. The method of claim 1, comprising displaying a project window as part of the user interface, the project window providing a view of the project structure for a particular project file.

10. The method of claim 1, comprising displaying a task window as part of the user interface, the task window providing information pertaining to the status of a plurality of tasks associated with the control system.

11. The method of claim 1, comprising automatically selecting a plurality of default options based upon options currently selected.

12. The method of claim 11, comprising altering the default options on a global basis.

13. A method for configuring a control system, the method comprising:
selecting mechanical equipment for a control system using a controller; and
based on the selected mechanical equipment, automatically identifying end devices from a database of end devices using a controller; and
determining control strategies for the control system based on the identified mechanical equipment.

14. The method of claim 13, comprising displaying an option list, the option list including available options for a corresponding selectable feature, the available options include control system components or characteristics.

15. The method of claim 14, comprising updating a plurality of the option lists to reflect which options are available for selection for the respective selectable features based upon the options currently selected.

16. The method of claim 15, comprising displaying at least one option list within a pop-up window, the pop-up window includes a text message providing information about the unavailability of an option currently not available for selection.

17. A user interface for designing a building control system, the user interface comprising:
a feature list displayed on a display screen, the feature list includes selectable features for building control system components and characteristics of a building control system; and
an option list displayed on the display screen, the option list includes available options for a corresponding selectable feature.

18. The user interface of claim 17, comprising a plurality of option lists, wherein after the selection of an available option, a plurality of option lists are updated to reflect which options are available for selection for the respective selectable features based upon the options currently selected.

19. The user interface of claim 18, wherein at least one updated option list includes options currently available and not available for selection, the options currently available for selection distinguished from the options currently not available for selection.

20. The user interface of claim 19, comprising a text message displayed as part of the user interface, the text message providing information regarding the unavailability of an option currently not available for selection.

21. The user interface of claim 18, wherein the available options include electrical and mechanical components of the building control system.

22. The user interface of claim 18, wherein at least one option list includes options that are combinable such that a plurality of options listed in the option list may be currently selected at the same time.

23. The user interface of claim 17, comprising a project window providing a view of the project structure for a particular project file.

24. The user interface of claim 23, comprising:
a menu bar displayed within the project window;
a plurality of buttons displayed within the menu bar, each button permits selection of a function to be performed by a processor; and
a box within the project window displaying a plurality of area icons, each area icon represents at least a portion of the building control system

25. The user interface of claim 24, comprising a plurality of feature icons displayed within the project window, each feature icon is graphically associated with an area icon, the feature icons representing at least sensors, detectors and coils of the building control system.

26. The user interface of claim 25, wherein each area icon represents a portion of the building control system determined by the physical location of the portion.

27. The user interface of claim 23, comprising a task window providing information pertaining to the status of a plurality of tasks associated with the building control system.

28. A user interface for designing a building control system, the user interface comprising:
a property window for selecting a plurality of features of a control system;
a feature list displayed within the property window, the feature list includes features of the control system;
a selection list displayed within the property window, the selection list includes any options currently selected, each option currently selected corresponding to a feature listed in the feature list;
a plurality of option lists accessible from the property window, each option list corresponding to a feature listed in the feature list and includes available options for the corresponding feature; and
one option list displayed as part of the user interface, wherein, upon the selection of an available option listed in the option list, multiple option lists corresponding to remaining features not having an option selected are updated to reflect any changes in the options available for selection for the respective remaining features based upon the options currently selected.

29. The user interface of claim 28, wherein a plurality of options corresponding to remaining features are automatically selected based upon the options currently selected.

30. The user interface of claim 29, wherein the options include different types of electrical and mechanical components, including valves, sensors, fans, ducts, dampers, coils, pumps, piping, chillers, boilers, terminal equipment, and detectors, of the control system.

31. The user interface of claim 29, wherein the option list is displayed in a pop-up window, the pop-up window also providing a text message regarding the unavailability of an option.

32. The user interface of claim 29, comprising a project window providing a view of the project structure for a particular project file.

33. The user interface of claim 29, comprising a task window providing information pertaining to the status of a plurality of tasks associated with the control system.

34. A computer-readable medium having instructions executable on a computer stored thereon, the instructions comprising:
displaying selectable features for building control system components and characteristics using a graphical user interface;
providing a corresponding list of available options for each selectable feature;
receiving data associated with an user-selected option;
storing data associated with the user-selected option; and
determining whether the available options in a plurality of the lists should be altered based upon the user-selected option.

35. The computer-readable medium of claim 34, comprising automatically selecting an option for a plurality of selectable features based upon a plurality of user-selected options.
